(19) United States
(12) Patent Application Publication
(10) Pub. No.: US 2022/0269092 A1
(43) Pub. Date: Aug. 25, 2022

(54) DISPLAY DEVICE INCLUDING POLARIZATION SELECTIVE MICROLENS ARRAY

(71) Applicant: Facebook Technologies, LLC, Menlo Park, CA (US)

(72) Inventors: Hyunmin SONG, Redmond, WA (US); Fenglin PENG, Redmond, WA (US); Yun-Han LEE, Redmond, WA (US); Stefanie TAUSHANOFF, Woodinville, WA (US); Mengfei WANG, Woodinville, WA (US)

(21) Appl. No.: 17/541,232

(22) Filed: Dec. 2, 2021

Related U.S. Application Data
(60) Provisional application No. 63/152,334, filed on Feb. 22, 2021.
(60) Provisional application No. 63/192,556, filed on May 24, 2021.

(51) Int. Cl. G02B 27/09; G02B 5/30; G02B 5/32

(52) U.S. Cl. CPC G02B 27/0961; G02B 5/3083; G02B 5/32

(57) ABSTRACT

A device includes a light source configured to output a light. The device also includes a display panel including a plurality of subpixel areas. The device also includes a microlens assembly disposed between the light source and the display panel. The microlens assembly includes a first microlens array configured to substantially collimate the light into a first polarized light, and a second microlens array configured to focus the first polarized light as a second polarized light propagating through apertures of the subpixel areas.

### CROSS REFERENCE TO RELATED APPLICATIONS

This application claims the benefit of priority to U.S. Provisional Application No. 63/152,334, filed on Feb. 22, 2021, and U.S. Provisional Application No. 63/192,556, filed on May 24, 2021. The contents of the above-mentioned applications are incorporated herein by reference in their entirety.

### TECHNICAL FIELD

The present disclosure generally relates to optical devices and, more specifically, to a display device including a polarization selective microlens array.

### BACKGROUND

Display technologies have been widely used in a large variety of applications in daily life, such as smartphones, tablets, laptops, monitors, TVs, projectors, vehicles, virtual reality (“VR”) devices, augmented reality (“AR”) devices, mixed reality (“MR”) devices, etc. Non-emissive displays, such as liquid crystal displays (“LCDs”), liquid-crystal-on-silicon (“LCoS”) displays, or digital light processing (“DLP”) displays, may require a backlight unit to illuminate a display panel. LCDs are attractive candidates for transparent displays and high luminance displays. Self-emissive displays may display images through emitting lights with different intensities and colors from light-emitting elements. Self-emissive displays may also function as a locally dimmable backlight unit for LCDs having a highly dynamic range. Self-emissive displays, such as organic light-emitting diode (“OLED”) displays, have been rapidly developed and implemented in the past few years. An OLED display can provide a high power efficiency, a superior dark state, a thin thickness, and a freeform factor, and has been widely used in TVs and smartphones. Emerging self-emissive displays, such as micro organic light-emitting diode (“μOLED”) displays, micro light-emitting diode (“μLED”) displays, mini-LED (“mLED”) displays, are promising technologies for next-generation displays. These displays offer ultra-high luminance and long lifetimes, which are highly desirable for sunlight readable displays, such as smartphones, public information displays, and vehicle displays.

### SUMMARY OF THE DISCLOSURE

One aspect of the present disclosure provides a device. The device includes a light source configured to output a light. The device also includes a display panel including a plurality of subpixel areas. The device also includes a microlens assembly disposed between the light source and the display panel. The microlens assembly includes a first microlens array configured to substantially collimate the light into a first polarized light, and a second microlens array configured to focus the first polarized light as a second polarized light propagating through apertures of the subpixel areas.

Another aspect of the present disclosure provides a device. The device includes a plurality of light-emitting elements configured to emit an image light. The device also includes a polarization converter including a plurality of converting regions and non-converting regions. The device further includes a microlens array disposed between the light-emitting elements and the polarization converter. The microlens array includes a plurality of microlenses configured to transform a first portion of the image light as a first polarized light that is incident onto the converting regions, and transform a second portion of the image light as a second polarized light that is incident onto both of the converting regions and the non-converting regions.

Other aspects of the present disclosure can be understood by those skilled in the art in light of the description, the claims, and the drawings of the present disclosure.

### BRIEF DESCRIPTION OF THE DRAWINGS

The accompanying drawings are provided for illustrative purposes according to various disclosed embodiments and are not intended to limit the scope of the present disclosure. In the drawings:

FIG. 1A schematically illustrates a display device, according to an embodiment of the present disclosure;

FIG. 1B schematically illustrates a thin-film transistor (“TFT”) array substrate that may be included in the display device shown in FIG. 1A, according to an embodiment of the present disclosure;

FIG. 1C schematically illustrates a color filter substrate that may be included in the display device shown in FIG. 1A, according to an embodiment of the present disclosure;

FIG. 1D schematically illustrates an optical path of a backlight in the display device shown in FIG. 1A, according to an embodiment of the present disclosure;

FIG. 1E schematically illustrates a beam spot of a backlight at a plane intersecting a subpixel area of the display device shown in FIG. 1A, according to an embodiment of the present disclosure;

FIG. 1F schematically illustrates a beam spot of a backlight at a plane intersecting a color filter of the display device shown in FIG. 1A, according to an embodiment of the present disclosure;

FIG. 1G schematically illustrates a display device, according to an embodiment of the present disclosure;

FIG. 1H schematically illustrates an optical path of a backlight in the display device shown in FIG. 1G, according to an embodiment of the present disclosure;

FIG. 2 schematically illustrates an optical path of a backlight in a conventional non-emissive display device;

FIGS. 3A and 3B schematically illustrate in-plane orientations of optically anisotropic molecules included in a Pancharatnam Berry Phase (“PBP”) microlens, according to an embodiment of the present disclosure;

FIGS. 3C and 3D schematically illustrate polarization selective focusing/defocusing of the PBP microlens shown in FIGS. 3A and 3B, according to an embodiment of the present disclosure;

FIG. 4A schematically illustrates a display device, according to an embodiment of the present disclosure;

FIG. 4B schematically illustrates an optical path of one of two orthogonally circularly polarized components of an image light in the display device shown in 4A, according to an embodiment of the present disclosure;

FIG. 4C schematically illustrates an optical path of the other one of two orthogonally circularly polarized components of the image light in the display device shown in 4A, according to an embodiment of the present disclosure;

FIG. 4D schematically illustrates a display device, according to an embodiment of the present disclosure;

FIGS. 5A-5C schematically illustrate polarization selective diffractions of a polarization volume hologram (“PVT”) microlens, according to an embodiment of the present disclosure;

FIG. 6 schematically illustrates an optical path of an image light in a conventional emissive display device;

FIG. 7A illustrates a schematic diagram of a near-eye display (“NED”), according to an embodiment of the present disclosure;

FIG. 7B illustrates a schematic cross sectional view of half of the NED shown in FIG. 7A, according to an embodiment of the present disclosure;

FIG. 8A schematically illustrates a diagram of an optical system, according to an embodiment of the present disclosure; and

FIG. 8B schematically illustrates a cross-sectional view of an optical path of an image light propagating through the optical system shown in FIG. 8A, according to an embodiment of the present disclosure.

### DETAILED DESCRIPTION

Embodiments consistent with the present disclosure will be described with reference to the accompanying drawings, which are merely examples for illustrative purposes and are not intended to limit the scope of the present disclosure. Wherever possible, the same reference numbers are used throughout the drawings to refer to the same or similar parts, and a detailed description thereof may be omitted.

Further, in the present disclosure, the disclosed embodiments and the features of the disclosed embodiments may be combined. The described embodiments are some but not all of the embodiments of the present disclosure. Based on the disclosed embodiments, persons of ordinary skill in the art may derive other embodiments consistent with the present disclosure. For example, modifications, adaptations, substitutions, additions, or other variations may be made based on the disclosed embodiments. Such variations of the disclosed embodiments are still within the scope of the present disclosure. Accordingly, the present disclosure is not limited to the disclosed embodiments. Instead, the scope of the present disclosure is defined by the appended claims.

As used herein, the terms “couple,” “coupled,” “coupling,” or the like may encompass an optical coupling, a mechanical coupling, an electrical coupling, an electromagnetic coupling, or any combination thereof. An “optical coupling” between two optical elements refers to a configuration in which the two optical elements are arranged in an optical series, and a light output from one optical element may be directly or indirectly received by the other optical element. An optical series refers to optical positioning of a plurality of optical elements in a light path, such that a light output from one optical element may be transmitted, reflected, diffracted, converted, modified, or otherwise processed or manipulated by one or more of other optical elements. In some embodiments, the sequence in which the plurality of optical elements are arranged may or may not affect an overall output of the plurality of optical elements. A coupling may be a direct coupling or an indirect coupling (e.g., coupling through an intermediate element).

The phrase “at least one of A or B” may encompass all combinations of A and B, such as A only, B only, or A and B. Likewise, the phrase “at least one of A, B, or C” may encompass all combinations of A, B, and C, such as A only, B only, C only, A and B, A and C, B and C, or A and B and C. The phrase “A and/or B” may be interpreted in a manner similar to that of the phrase “at least one of A or B.” For example, the phrase “A and/or B” may encompass all combinations of A and B, such as A only, B only, or A and B. Likewise, the phrase “A, B, and/or C” has a meaning similar to that of the phrase “at least one of A, B, or C.” For example, the phrase “A, B, and/or C” may encompass all combinations of A, B, and C, such as A only, B only, C only, A and B, A and C, B and C, or A and B and C.

When a first element is described as “attached,” “provided,” “formed,” “affixed,” “mounted,” “secured,” “connected,” “bonded,” “recorded,” or “disposed,” to, on, at, or at least partially in a second element, the first element may be “attached,” “provided,” “formed,” “affixed,” “mounted,” “secured,” “connected,” “bonded,” “recorded,” or “disposed,” to, on, at, or at least partially in the second element using any suitable mechanical or non-mechanical manner, such as depositing, coating, etching, bonding, gluing, screwing, press-fitting, snap-fitting, clamping, etc. In addition, the first element may be in direct contact with the second element, or there may be an intermediate element between the first element and the second element. The first element may be disposed at any suitable side of the second element, such as left, right, front, back, top, or bottom.

When the first element is shown or described as being disposed or arranged “on” the second element, term “on” is merely used to indicate an example relative orientation between the first element and the second element. The description may be based on a reference coordinate system shown in a figure, or may be based on a current view or example configuration shown in a figure. For example, when a view shown in a figure is described, the first element may be described as being disposed “on” the second element. It is understood that the term “on” may not necessarily imply that the first element is over the second element in the vertical, gravitational direction. For example, when the assembly of the first element and the second element is turned 180 degrees, the first element may be “under” the second element (or the second element may be “on” the first element). Thus, it is understood that when a figure shows that the first element is “on” the second element, the configuration is merely an illustrative example. The first element may be disposed or arranged at any suitable orientation relative to the second element (e.g., over or above the second element, below or under the second element, left to the second element, right to the second element, behind the second element, in front of the second element, etc.).

When the first element is described as being disposed “on” the second element, the first element may be directly or indirectly disposed on the second element. The first element being directly disposed on the second element indicates that no additional element is disposed between the first element and the second element. The first element being indirectly disposed on the second element indicates that one or more additional elements are disposed between the first element and the second element.

The term “processor” used herein may encompass any suitable processor, such as a central processing unit (“CPU”), a graphics processing unit (“GPU”), an application-specific integrated circuit (“ASIC”), a programmable logic device (“PLD”), or any combination thereof. Other processors not listed above may also be used. A processor may be implemented as software, hardware, firmware, or any combination thereof.

The term “controller” may encompass any suitable electrical circuit, software, or processor configured to generate a control signal for controlling a device, a circuit, an optical element, etc. A “controller” may be implemented as software, hardware, firmware, or any combination thereof. For example, a controller may include a processor, or may be included as a part of a processor.

The term “non-transitory computer-readable medium” may encompass any suitable medium for storing, transferring, communicating, broadcasting, or transmitting data, signal, or information. For example, the non-transitory computer-readable medium may include a memory, a hard disk, a magnetic disk, an optical disk, a tape, etc. The memory may include a read-only memory (“ROM”), a random-access memory (“RAM”), a flash memory, etc.

The term “film,” “layer,” “coating,” or “plate” may include rigid or flexible, self-supporting or free-standing film, layer, coating, or plate, which may be disposed on a supporting substrate or between substrates. The terms “film,” “layer,” “coating,” and “plate” may be interchangeable.

The phrases “in-plane direction,” “in-plane orientation,” “in-plane rotation,” “in-plane alignment pattern,” and “in-plane pitch” refer to a direction, an orientation, a rotation, an alignment pattern, and a pitch in a plane of a film or a layer (e.g., a surface plane of the film or layer, or a plane parallel to the surface plane of the film or layer), respectively. The term “out-of-plane direction” or “out-of-plane orientation” indicates a direction or orientation that is non-parallel to the plane of the film or layer (e.g., perpendicular to the surface plane of the film or layer, e.g., perpendicular to a plane parallel to the surface plane). For example, when an “in-plane” direction or orientation refers to a direction or orientation within a surface plane, an “out-of-plane” direction or orientation may refer to a thickness direction or orientation perpendicular to the surface plane, or a direction or orientation that is not parallel with the surface plane.

The term “orthogonal” as used in “orthogonal polarizations” or the term “orthogonally” as used in “orthogonally polarized” means that an inner product of two vectors representing the two polarizations is substantially zero. For example, two lights with orthogonal polarizations or two orthogonally polarized lights may be two linearly polarized lights with polarizations in two orthogonal directions (e.g., an x-axis direction and a y-axis direction in a Cartesian coordinate system) or two circularly polarized lights with opposite handednesses (e.g., a left-handed circularly polarized light and a right-handed circularly polarized light).

In the present disclosure, an angle of a beam (e.g., a diffraction angle of a diffracted beam or an incidence angle of an incident beam) with respect to a normal of a surface can be defined as a positive angle or a negative angle, depending on the angular relationship between a propagating direction of the beam and the normal of the surface. For example, when the propagating direction of the beam is clockwise from the normal, the angle of the propagating direction may be defined as a positive angle, and when the propagating direction of the beam is counter-clockwise from the normal, the angle of the propagating direction may be defined as a negative angle.

The term “substantially” or “primarily” used to modify an optical response action, such as “transmit,” “reflect,” “diffract,” “block” or the like that describes processing of a light means that a majority portion, including all, of the light is transmitted, reflected, diffracted, or blocked, etc. The majority portion may be a predetermined percentage (greater than 50%) of the entire light, such as 100%, 95%, 90%, 85%, 80%, etc., which may be determined based on specific application needs.

Conventional LCD displays have a limited energy efficiency, as polarizers and color filters block more than 70% of the backlight. Conventional OLED displays may be more energy efficient that LCD displays. An OLED display may include an OLED panel and a circular polarizer laminated on top of the OLED panel. The circular polarizer is used to block a reflected ambient light from bottom reflective electrodes of OLED chips in the OLE panel, thereby increasing the contrast ratio of the OLED display. However, the circular polarizer may also reduce the energy efficiency of the OLED display. High energy efficiency and high resolution displays are desirable in various applications.

In view of the limitations of the conventional technologies, the present disclosure provides display devices with enhanced light transmittance. The present disclosure provides non-emissive display devices (e.g., LCD displays) with enhanced light transmittance. In some embodiments, the device may include a light source configured to output a light. The device may also include a display panel including a plurality of subpixel areas. The device may also include a microlens assembly disposed between the light source and the display panel. The microlens assembly may include a first microlens array configured to substantially collimate the light into a first polarized light, and a second microlens array configured to focus the first polarized light as a second polarized light propagating through apertures of the subpixel areas. In some embodiments, the second polarized light may propagate substantially entirely through the apertures of the subpixel areas.

In some embodiments, the display panel may include a plurality of color filters, and the second polarized light may propagate substantially entirely through the color filters. In some embodiments, the first microlens array may be a first Pancharatnam Berry Phase (“PBP”) microlens array, and the second microlens array may be a second PBP microlens array. In some embodiments, each subpixel area of the plurality of subpixel areas may include a subpixel electrode and a switching element of the subpixel electrode, the subpixel electrode corresponding to an aperture of the subpixel area, and the switching element corresponding to a non-transparent portion of the subpixel area. In some embodiments, the first polarized light and the second polarized light may be circularly polarized lights having opposite handednesses. In some embodiments, the light output from the light source may be a circularly polarized light.

In some embodiments, an alignment offset between the first microlens array or the second microlens array and an array formed by the apertures of the subpixel regions may be less than or equal to 2 μm. In some embodiments, the first polarized light may have a collimation angle that is within a range of about 5° to about 15°. In some embodiments, the microlens assembly may include a waveplate disposed between the second microlens array and the display panel. In some embodiments, the microlens assembly may include a reflective polarizer disposed between the waveplate and the display panel, and a linear polarizer disposed between the reflective polarizer and the display panel.

The present disclosure also provides emissive display devices (e.g., LED, OLED displays) with enhanced light transmittance. In some embodiments, the device may include a plurality of light-emitting elements configured to emit an image light. In some embodiments, the device may also include a polarization converter including a plurality of converting regions and non-converting regions. The device may include a microlens array disposed between the light-emitting elements and the polarization converter. The microlens array may include a plurality of microlenses configured to transform a first portion of the image light as a first polarized light that is incident onto the converting regions, and transform a second portion of the image light as a second polarized light that is incident onto both of the converting regions and the non-converting regions.

In some embodiments, the microlens array may include a transmissive polarization volume hologram (“PVH”) microlens array. In some embodiments, the microlens may include a plurality of central portions and periphery portions. In some embodiments, the microlenses may include a plurality of central portions and periphery portions. The first portion of the image light may include portions of the image light that are incident onto central portions of the microlenses and that are circularly polarized with a first handedness. The second portion of the image light may include a combination of portions of the image light that are incident onto the central portions of the microlenses and that are circularly polarized with a second handedness, and portions of the image light that are incident onto the periphery portions of the microlenses.

In some embodiments, a beam size of the first polarized light at a plane intersecting one of the converting regions may be configured to be the same as or smaller than a size of the one of the converting regions. In some embodiments, an alignment offset between the microlens array and the light-emitting elements may be less than or equal to 2 μm. In some embodiments, the first polarized light may have a first polarization, and the second polarized light may have a second polarization that is orthogonal to the first polarization. In some embodiments, the second polarized light may include first portions incident onto the converting regions and second portions incident onto the non-converting regions. The converting regions may be configured to convert the first polarized light having the first polarization into a third polarized light having the second polarization, and convert the first portions of the second polarized light having the second polarization into a fourth polarized light having the first polarization. In some embodiments, the non-converting regions may be configured to transmit the second portions of the second polarized light having the second polarization as a fifth polarized light having the second polarization.

In some embodiments, the device may further include a circular polarizer configured to substantially transmit the third polarized light having the second polarization and the fifth polarized light having the second polarization, and substantially block the fourth polarized light having the first polarization. In some embodiments, the circular polarizer may include a first waveplate, a linear polarizer, and a second waveplate stacked together.

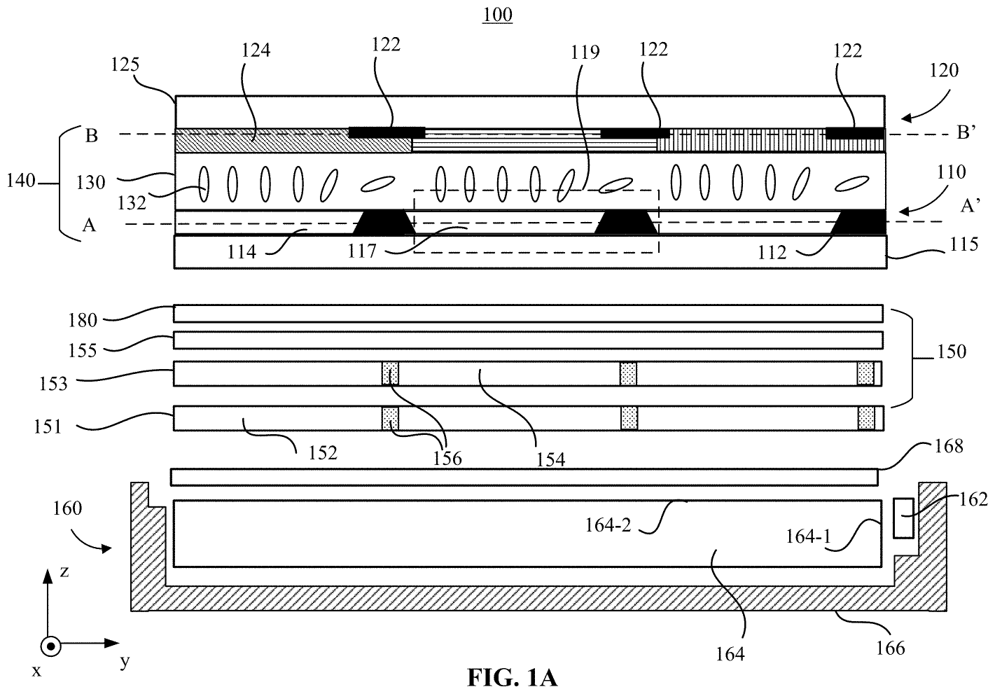

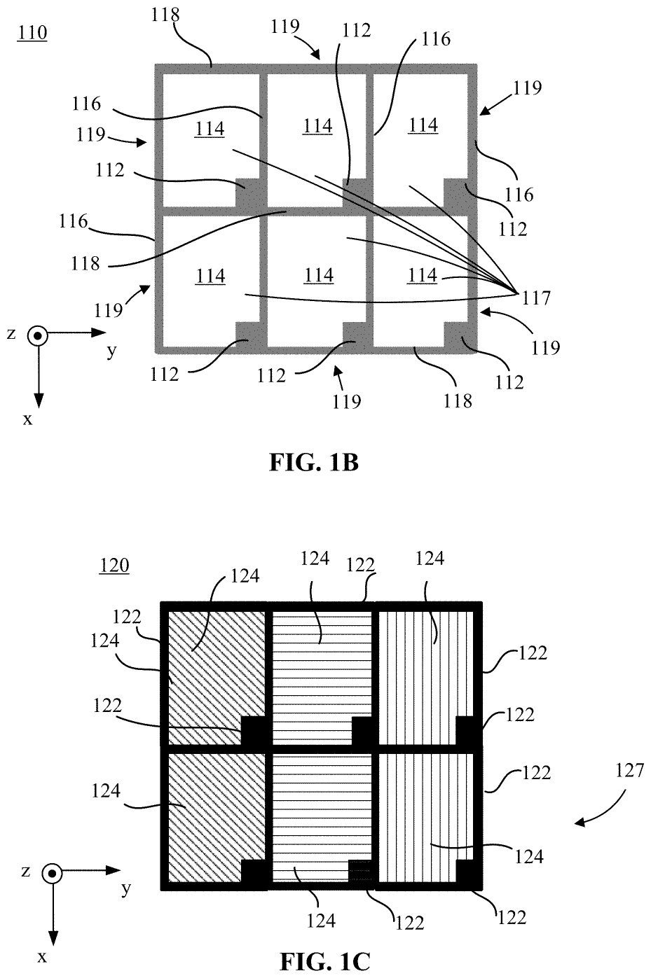

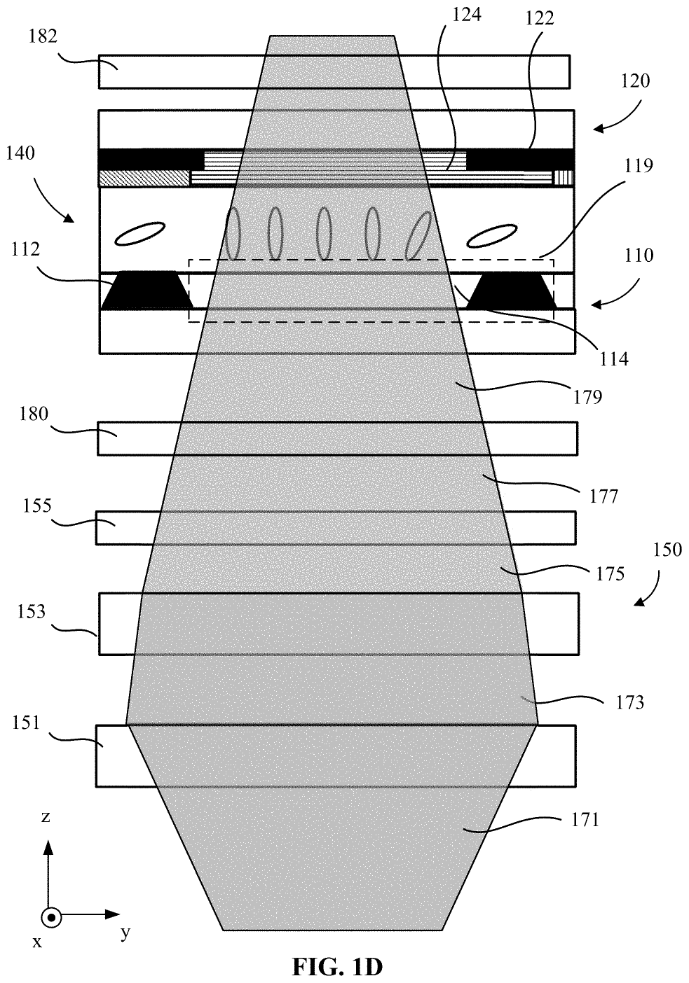

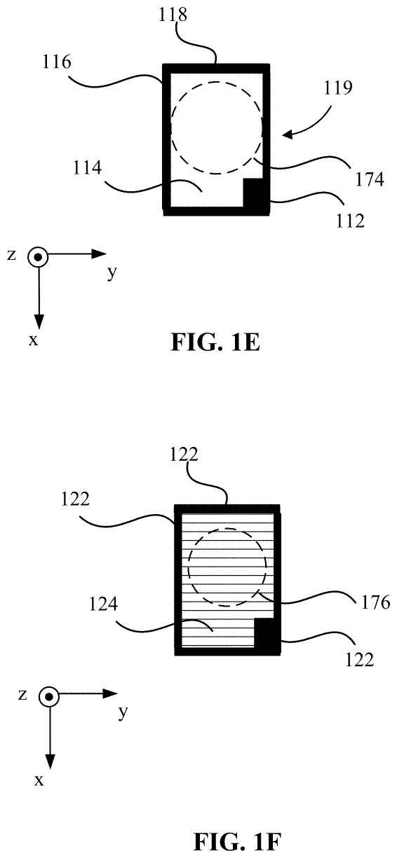

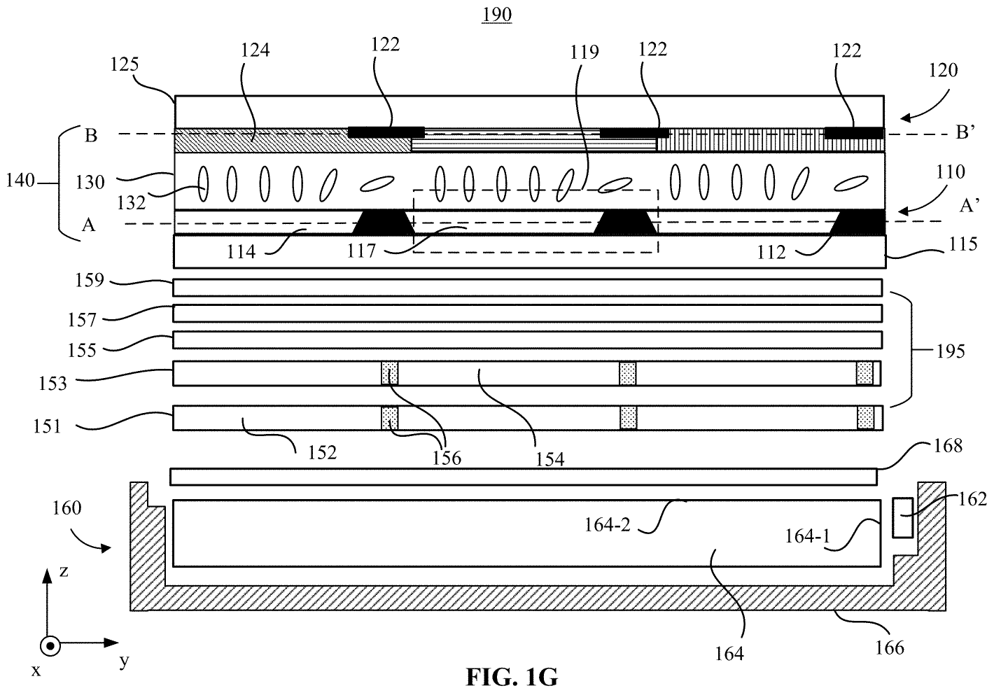

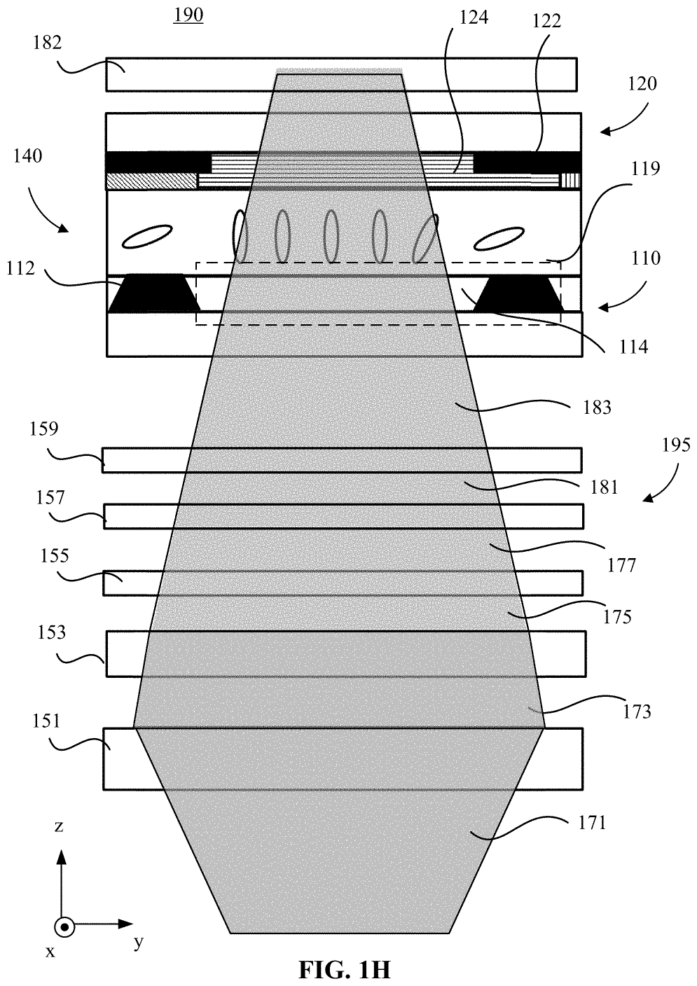

FIG. 1A schematically illustrates a y-z sectional view of a display device 100, according to an embodiment of the present disclosure. As shown in FIG. 1A, the display device 100 may include a display panel 140, a light source 160, and a microlens assembly 150 disposed between the display panel 140 and the light source 160. In some embodiments, the light source 160 may be a backlight unit. For illustrative purposes, the backlight unit is used as an example of the light source 160. In below descriptions, for discussion purposes, the light source 160 is also referred to as the backlight unit 160.

For illustrative purposes, FIG. 1A shows the display panel 140, the microlens assembly 150, and the backlight unit 160 as having flat surfaces. In some embodiments, one or more of the display panel 140, the microlens assembly 150, and the backlight unit 160 may include one or more elements having curved surfaces. The backlight unit 160 may be configured to emit a backlight for illuminating the display panel 140. The microlens assembly 150 may be configured to redirect the backlight output from the backlight unit 160 to illuminate the display panel 140. In some embodiments, the backlight unit 160 may include a backlight source assembly 162, a light guide plate 164, a back frame 166. The backlight source assembly 162 may be disposed adjacent a light incident surface 164-1 of the light guide plate 164, and may output a backlight to the light incident surface 164-1. The backlight source assembly 162 may include one or more light-emitting diodes (“LEDs”), one or more organic light-emitting diodes (“OLEDs”), an electroluminescent panel (“ELP”), one or more cold cathode fluorescent lamps (“CCFLs”), one or more hot cathode fluorescent lamps (“HCFLs”), or one or more external electrode fluorescent lamps (“EEFLs”), etc. In some embodiments, the LED (or OLED) backlight source may include a plurality of white LEDs (or OLEDs), or a plurality of red LEDs (or OLEDs), green LEDs (or OLEDs), and blue LEDs (or OLEDs), etc. The light guide plate 164 may be fabricated based on a light transmitting material, such as a transparent acryl resin or the like. The backlight entering from the light incident surface 164-1 of the light guide plate 164 may propagate inside the light guide plate 164, and may exit the light guide plate 164 at a light output surface 164-2 toward the microlens assembly 150.

In some embodiments, the backlight unit 160 may also include one or more optical elements arranged between the light guide plate 164 and the microlens assembly 150, and configured to transform the backlight output from the light guide plate 164 into a polarized light having a predetermined polarization. For example, the backlight output from the light guide plate 164 may be a linearly polarized light, and the backlight unit 160 may include a waveplate 168 arranged between the light guide plate 164 and the microlens assembly 150. The waveplate 168 may be configured to convert the linearly polarized light output from the light guide plate 164 into a circularly polarized light having a predetermined handedness. In some embodiments, the waveplate 168 may function as a broadband and wide angle quarter-wave plate (“QWP”) configured to provide a quarter-wave birefringence (or quarter-wave phase retardance) across a wide spectral range (or wavelength range) (e.g., visible spectrum) to the linearly polarized light. In some embodiments, for an achromatic design, the waveplate 168 may include a multi-layer birefringent material (e.g., a polymer or liquid crystals) configured to provide a quarter-wave birefringence (or quarter-wave phase retardance) across a wide spectral range (or wavelength range) (e.g., visible spectrum). In some embodiments, the backlight output from the light guide plate 164 may be a circularly polarized light having a predetermined handedness, and the waveplate 168 may be omitted.

In some embodiments, the backlight unit 160 may also include one or more diffuser sheets and/or prism sheets (not shown) arranged between the light guide plate 164 and the microlens assembly 150, or between the waveplate 168 (when included) and the microlens assembly 150. The one or more diffuser sheets and/or prism sheets may be configured to improve the brightness uniformity of the backlight output from the light guide plate 164, suppress or reduce undesirable hotspots with point or linear light sources in the backlight source assembly 162, etc.

In some embodiments, the display panel 140 may be any suitable non-emissive display panel, such as a liquid crystal display (“LCD”) panel, a liquid crystal on silicon (“LCoS”) panel, etc. The display panel 140 may include a thin-film transistor (“TFT”) array substate 110, a liquid crystal (“LC”) layer 130, and a color filter substrate 120 stacked together. The LC layer 130 may be disposed between the TFT array substate 110 and the color filter substate 120. The display panel 140 may include other elements, such as a polarizer disposed at an outer surface of the TFT array substate 110, and an analyzer disposed at an outer surface of the color filter substate 120.

FIG. 1B schematically illustrates an A-A′ sectional view of the TFT array substrate 110 included in the display panel 140 shown in FIG. 1A, according to an embodiment of the present disclosure. As shown in FIGS. 1A and 1, the TFT array substate 110 may include a first substrate 115. The TFT array substate 110 may include a plurality of subpixel areas 119 or subpixels 119, in which a pixel electrode layer 117 is formed. The pixel electrode layer 117 and the subpixel areas 119 may be formed at a surface of the first substrate 115. The plurality of subpixel areas 119 may be defined by a plurality of data lines 116 and a plurality of gate lines 118. As shown in FIG. 1B, the data lines 116 may be arranged in parallel and may extend in a first direction (e.g., an x-axis direction in FIG. 1). The gate lines 118 may be arranged in parallel and may extend in a second, different direction (e.g., a y-axis direction in FIG. 1). The data lines 116 and the gate lines 118 may intersect one another. The pixel electrode layer 117 may be formed by a plurality of subpixel electrodes 114 formed within the subpixel areas 119. The TFT array substrate 110 may also include a plurality of TFTs 112 arranged in an array. As shown in FIG. 1A, the TFTs 112 may be also disposed at the first substrate 115. Each subpixel area 119 is shown in FIG. 1B as a small rectangular area enclosed by portions of the data lines 116 and portions of the gate lines 118, and including a subpixel electrode 114, and a TFT 112 disposed at a corner where a portion of a data line 116 and a portion of a gate line 118 intersect. The rectangular shape is for illustration purpose, and the subpixel area 119 may include any suitable shape. The plurality of subpixel areas 119 may have the same structure, and may be repeatedly defined at the first substrate 115. In some embodiments, a pixel may include three subpixels, e.g., red (“R”), green (“G”), and blue (“B”) subpixels. Thus, a pixel may be formed by three subpixel areas 119.

The pixel electrode layer 117 including the subpixel electrodes 114 may be a conductive transparent electrode layer. As shown in FIG. 1A and FIG. 1, each subpixel electrode 114 may occupy a portion of the subpixel area 119 other than the area where the TFT 112 and the corresponding metal wires (e.g., portions of the data line 116 and gate line 118) are located. The TFT 112 may be a switching element of the subpixel area 119. The TFT 112 may be electrically connected to a corresponding subpixel electrode 114, a corresponding gate line 118, and a corresponding data line 116. The TFT 112 may be controlled by the corresponding gate line 118 and the corresponding data line 116.

FIG. 1C schematically illustrates a B-B′ sectional view of the color filter substate 120 included in the display panel 140 shown in FIG. 1A, according to an embodiment of the present disclosure. As shown in FIG. 1A, the color filter substrate 120 and the TFT array substrate 110 may be stacked, and may include components corresponding to one another in spatial positions. As shown in FIG. 1A, the color filter substate 120 may include a second substate 125 disposed in parallel with the first substrate 115 of the TFT array substate 110. The color filter substrate 120 may also include a light shielding material layer 122 (formed by all of the thick black portions shown in FIG. 1C) and a color filter layer 127 disposed at a surface of the second substate 125 facing the TFT array substrate 110. As shown in FIG. 1C, the color filter layer 127 may include a plurality of color filters 124 disposed within regions enclosed by the light shielding material layer 122. In some embodiments, the light shielding material layer 122 may include a black matrix. For discussion purposes, the light blocking material layer 122 is also referred to the black matrix 122 in the following descriptions. As shown in FIG. 1C, the color filters 124 may be separated from one another by the black matrix 122 disposed at the peripheries of the color filters 124. Corresponding to each subpixel area 119 shown in FIG. 1B, the black matrix 122 include portions covering the gate lines 118 and the data lines 116 that define the rectangular area (subpixel area 119), and a portion covering the TFT 112 disposed at the corner where the gate line 118 and the data line 116 intersect. Hence, as shown in FIG. 1B and FIG. 1C, the shape of the black matrix 122 is substantially the same as the shape of the data lines 116, the gate lines 118, and the TFTs 112.

In some embodiments, the color filters 124 may include red (R), green (G) and blue (B) color filters, denoted by different patterns in FIGS. 1A and 1C. In some embodiments, the color filter layer 127 may include color filters 124 other than the red (R), green (G), or blue (B) color filters, which are not limited by the present disclosure. The color filter 124 may include any suitable material that substantially transmits the backlight having a predetermined color and/or emits a light having a predetermined color when illuminated by the backlight. In some embodiments, the color filter 124 may include a color resist configured to substantially transmit the backlight having a predetermined color. In some embodiments, the color filter 124 may include one or more color conversion materials that absorbs the backlight and emit lights having one or more predetermined colors. For example, the color conversion material may include a quantum dot material that may enhance the energy efficiency and the color performance. For discussion purposes, the color filter 124 including the color resist is used as example in the following description.

As shown in FIGS. 1A-1C, the subpixel electrodes 114 of the TFT array substate 110 and the color filters 124 of the color filter substrate 120 may correspond to one another in position and shape. That is, the gray portions in FIG. 1B may correspond to the black portions in FIG. 1C in the thickness direction of the display device 100, as shown in FIG. 1A. The TFT 112 may be opaque, and may at least partially block a backlight incident onto the TFT 112. For example, the TFT 112 may at least partially reflect and/or absorb the backlight incident onto the TFT 112. The subpixel electrode 114 may be substantially transparent to the backlight, and may substantially not reflect and/or absorb the backlight. The subpixel electrode 114 may also be referred to as a transparent portion of the subpixel area 119, or an aperture of the subpixel area 119. The backlight output from the backlight unit 160 may be guided to propagate through the apertures of the subpixel areas 119. In some embodiments, substantially the entire backlight may propagate through the apertures. A combination of the apertures of the plurality of subpixel areas 119 in the TFT array substate 110 may form an overall aperture of the TFT array substate 110. With the disclosed microlens assembly 150, substantially the entire backlight output from the backlight unit 160 may be guided to propagate through the overall aperture of the TFT array substrate 110, thereby increasing the light transmittance or efficiency.

The metal wires (e.g., portions of the data lines 116 and the gate lines 118) that form each subpixel area 119 and the TFT 112 may be covered by corresponding portions of the black matrix 122 included in the color filter substrate 120. The black matrix 122 may include a light-shielding material, e.g., for absorbing the backlight, thereby hiding the TFTs 112 and various metal wires from being perceived by a viewer of the display device 100. The portion of the subpixel area 119 including various metal wires (e.g., the data lines 116 and the gate lines 118) and the TFT 112 may be referred to as a non-transparent portion of the subpixel area 119. A combination of the non-transparent portions of the plurality of the subpixel area 119 included in the TFT array substate 110 may form an overall non-transparent portion of the TFT array substate 110. An aperture ratio of the display panel 140 may be referred to as a ratio between the area of the transparent portion (or aperture) and the area of the subpixel area 119. When the number of subpixels 119 included in the display panel 140 is fixed, the light transmittance of the display panel 140 may increase as the aperture ratio increases.

The color filters 124 may be illuminated by the backlight, and may output lights of corresponding colors. In other words, the color filters 124 may be substantially transparent to the lights of the corresponding colors. The black matrix 122 may substantially block (e.g., absorb, and/or reflect) the backlight. For discussion purpose, a combination of the color filters 124 may form an overall aperture of the color filter substate 120. The black matrix 122 may form an overall non-transparent portion of the color filter substate 120.

The display panel 140 may include a common electrode layer (e.g., conductive transparent electrode layer, not shown) disposed at one of the color filter substrate 120 or the TFT array substate 110. The display panel 140 may individually control (e.g., through the corresponding TFTs 112) the light transmittance of the subpixels 119 by controlling orientations of corresponding liquid crystal molecules 132. The orientations may be controlled by supplying and controlling electric fields generated between the respective subpixel electrodes 114 and the common electrode layer. A backlight output from the backlight unit 160 may be transmitted through the display panel 140 to display a color image.

In some embodiments, the display panel 140 may include other elements not shown in FIGS. 1A-1C. For example, the display panel 140 may include two alignment layers respectively disposed at each of the color filter substrate 120 and the TFT array substate 110, two crossed polarizers (e.g., a polarizer and an analyzer) respectively disposed at outer surfaces of the color filter substrate 120 and the TFT array substate 110, one or more insulating layers disposed between different groups of metal wires (e.g., between the data lines 116 and the gate lines 118), one or more insulating layers disposed between the pixel electrode layer 127 and the common electrode layer, one or more insulating layers disposed between the electrode layer (e.g., the pixel electrode layer 127 and/or the common electrode layer) and the metal wires, and/or storage capacitors disposed in overlapping regions between the pixel electrode layer 127 and the common electrode layer.

Referring to FIG. 1A, the microlens assembly 150 may be disposed at a light output side of the backlight unit 160, and at a light incident side of the display panel 140. In other words, the microlens assembly 150 may be disposed “on-cell” with respect to the display panel 140. The microlens assembly 150 may include a first microlens array 151 and a second microlens array 153 disposed in parallel. In the embodiment shown in FIG. 1A, the first microlens array 151 is shown as spaced apart from the second microlens array 153 by a gap. In some embodiments, the first microlens array 151 and the second microlens array 153 may be stacked without a gap. The first microlens array 151 may include a plurality of first microlenses 152 arranged in a first array. The second microlens array 153 may include a plurality of second microlenses 154 arranged in a second array. The first microlens array 151 and the second microlens array 153 may be substantially aligned with one another. Each of the plurality of first microlenses 152 may correspond to each of the plurality of second microlenses 154 in shape and position. In some embodiments, the first microlens array 151 and/or the second microlens array 153 may be optically patterned with the first microlenses 152 and/or the second microlenses 154. In some embodiments, neighboring first microlenses 152 in the first microlens array 151 and/or neighboring second microlenses 154 in the second microlens array 153 may be separated by dividers 156, which may be virtual dividers or actual dividers.

In some embodiments, the first microlens array 151 and/or the second microlens array 153 may be substantially aligned with an array formed by the subpixels 119. In some embodiments, the first microlens array 151 and/or the second microlens array 153 may be substantially aligned with an array formed by the apertures (or the transparent portions) of the subpixels 119. For example, the first microlenses 152 and/or the second microlenses 152 may be substantially aligned with the subpixel electrodes 114 of the subpixel areas 119. In some embodiments, the first microlens array 151 and/or the second microlens array 153 may be aligned “on-cell” with an alignment offset (or alignment displacement) of less than or equal to 2 μm with respect to the array of apertures (or subpixel electrodes 114) of the subpixels 119. In some embodiments, the first microlens array 151 and/or the second microlens array 153 may be aligned “on-cell” with an alignment offset (or alignment displacement) of less than or equal to 1 μm with respect to the array of apertures (or subpixel electrodes 114) of the subpixels 119. In some embodiments, the first microlens array 151 and/or the second microlens array 153 may be aligned “on-cell” with an alignment offset (or alignment displacement) of less than or equal to 100 nanometers (“nm”) with respect to the array of apertures (or subpixel electrodes 114) of the subpixels 119.

In some embodiments, the microlens assembly 150 may be a polarization selective microlens assembly (also referred to as 150 for discussion purposes). For example, at least one (e.g., both) of the first microlens array 151 or (and) the second microlens array 153 may be polarization selective microlens array configured to provide a polarization selective optical response. In some embodiments, the first microlenses 152 may be polarization selective microlenses. In some embodiments, the second microlenses 154 may be polarization selective microlenses. In some embodiments, the first microlenses 152 and the second microlenses 154 may all be polarization selective microlenses. The first microlens array 151 and the second microlens array 153 may also be referred to as a first polarization selective microlens array 151 and a second polarization selective microlens array 153, respectively. The first microlenses 152 and second microlenses 154 may also be referred to as first polarization selective microlenses 152 and second polarization selective microlenses 154, respectively.

In some embodiments, at least one (e.g., both) of the first polarization selective microlens array 151 or (and) the second polarization selective microlens array 153 may be circularly polarization selective. For example, at least one of the first polarization selective microlens array 151 or the second polarization selective microlens array 153 may be configured to operate in a first optical state to provide a first optical response to a circularly polarized light having a predetermined handedness, and operate in a second optical state to provide a second optical response different from the first optical response to a circularly polarized light having a handedness that is opposite to the predetermined handedness. In some embodiments, at least one (e.g., both) of the first polarization selective microlens array 151 or (and) the second polarization selective microlens array 153 may be a Pancharatnam Berry Phase (“PBP”) microlens array, and at least one (e.g., both) of the first polarization selective microlenses 152 or (and) the second polarization selective microlenses 154 may be PBP microlenses. In some embodiments, the PBP microlens array may include at least one of sub-wavelength structures (e.g., a metamaterial), a birefringent material (e.g., an LC material), or a photo-refractive holographic material (e.g., an amorphous polymer). In some embodiments, the PBP microlens array may be a liquid crystal polymer (“LCP”) microlens array. In other words, the first polarization selective microlens array 151 or the second polarization selective microlens array 153 may be an LCP-based PBP microlens array.

A PBP microlens array or a PBP microlens may be configured to modulate a circularly polarized light based on a phase profile provided through a geometric phase. In some embodiments, a PBP microlens array or a PBP microlens may be configured to operate in a focusing (or converging) state for a circularly polarized light having a predetermined handedness, and operate in a defocusing (or diverging) state for a circularly polarized light having a handedness that is opposite to the predetermined handedness. In addition, a PBP microlens array or a PBP microlens may reverse the handedness of a circularly polarized light transmitted therethrough while focusing or defocusing the circularly polarized light. For example, in some embodiments, a PBP microlens or PBP microlens array may be configured to operate in a focusing (or converging) state to focus (or converge) a right-handed circularly polarized (“RHCP”) light as a left-handed circularly polarized (“LHCP”) light, and operate in a defocusing (or diverging) state to defocus (or diverge) an LHCP light as an RHCP light. In some embodiments, a PBP microlens or PBP microlens array may be configured to operate in a focusing (or converging) state to focus (or converge) an LHCP light as an RHCP light, and operate in a defocusing (or diverging) state to defocus (or diverge) an RHCP light as an LHCP light.

FIG. 1D schematically illustrates an optical path of a backlight propagating in the display device 100 shown in FIG. 1A, according to an embodiment of the present disclosure. For discussion purposes, FIG. 1D shows a portion of the optical path of the backlight propagating through a single subpixel or subpixel area 119. Optical paths of the backlight propagating through other areas of the display device 100 may be substantially the same as that shown in FIG. 1D. For discussion purposes, in the embodiment shown in FIG. 1D, the backlight unit 160 (not shown) may be configured to output a diffused backlight 171 that is a circularly polarized light having a predetermined handedness (e.g., an RHCP light). The diffused backlight 171 may also be referred to as a circularly polarized light 171 for discussion purposes. Referring to FIG. 1A and FIG. 1D, the light guide plate 164 may be configured to output a linearly polarized light, and the waveplate 168 may be configured to convert the linearly polarized light to a circularly polarized light having the predetermined handedness (e.g., an RHCP light). In some embodiments, the light guide plate 164 may be configured to directly output a circularly polarized light having the predetermined handedness (e.g., an RHCP light), and the waveplate 168 may be omitted. In some embodiments, the one or more diffuser sheets and/or prism sheets (not shown) arranged between the light guide plate 164 and the microlens assembly 150 (or between the waveplate 168 when included and the microlens assembly 150) may be configured to diffuse the circularly polarized light output from the light guide plate 164 (or the waveplate 168 when included) as the circularly polarized light (e.g., RHCP light) 171 propagating toward the microlens assembly 150.

Referring back to FIG. 1D, the polarization selective microlens assembly 150 may be configured to focus the circularly polarized light (e.g., RHCP light) 171, such that the circularly polarized light may propagate through the aperture of the subpixel area 119 in the TFT array substate 110 and the color filter 124 in the color filter substrate 120. Without the polarization selective microlens assembly 150, the circularly polarized light 171 may have a larger beam size at a plane intersecting the aperture of the subpixel area 119 and/or a plane intersecting the color filter 124. As a result, a portion of the circularly polarized light 171 may be incident onto the TFTs 112 and/or the black matrix 122 surrounding the aperture of the subpixel area 119, and may be reflected back toward the backlight unit 160 by the TFTs 112, absorbed by the TFTs 112, and/or absorbed by the black matrix 122. With the polarization selective microlens assembly 150 reducing the beam size of the circularly polarized light 171 at the plane intersecting the aperture of the subpixel area 119 and/or the plane intersecting the color filter 124 through focusing the circularly polarized light 171, an increased amount of the circularly polarized light 171 may propagate through the aperture area (i.e., the subpixel electrode 114) of the subpixel area 119 and/or the color filter 124. In some embodiments, substantially the entire circularly polarized light 171 may propagate through the subpixel electrode 114 of the subpixel area 119 and the color filter 124, with no portion or only a negligible portion of the circularly polarized light 171 being incident onto the TFTs 112 and being blocked (e.g., absorbed and/or reflected) by the TFTs 112. Thus, the light transmittance of the display panel 140 may be increased, and the power efficiency of the entire display device 100 may be enhanced.

For discussion purposes, in the embodiment shown in FIG. 1D, when the circularly polarized light 171 incident onto the polarization selective microlens assembly 150 is an RHCP light, the first PBP microlens array 151 may be configured to focus an RHCP light as an LHCP light, and defocus an LHCP light as an RHCP light. The second PBP microlens array 153 may be configured to focus an LHCP light as an RHCP light, and defocus an RHCP light as an LHCP light. In some embodiments, when the circularly polarized light 171 incident onto the polarization selective microlens assembly 150 is an LHCP light, the first PBP microlens array 151 may be configured to focus an LHCP light as an RHCP light, and defocus an RHCP light as an LHCP light. The second PBP microlens array 153 may be configured to focus an RHCP light as an LHCP light, and defocus an LHCP light as an RHCP light.

As shown in FIG. 1D, the first PBP microlens array 151 may function as a condenser microlens array configured to collect and collimate the circularly polarized light (e.g., RHCP light) 171 as a circularly polarized light (e.g., an LHCP light) 173 propagating toward the second PBP microlens array 153. The second PBP microlens array 153 may be configured to focus the circularly polarized light (e.g., LHCP light) 173 as a circularly polarized light (e.g., an RHCP light) 175. In the embodiment shown in FIG. 1D, substantially the entire circularly polarized light 175 may propagate through the aperture of the subpixel area 119 in the TFT array substate 110 and the color filter 124 in the color filter substrate 120. No portion of the circularly polarized light (e.g., RHCP light) 175 output from the second PBP microlens array 153 may be incident onto the TFTs 112 and/or the black matrix 122 (or the portion incident onto the TFTs 112 and/or the black matrix 122 may be significantly reduced to a negligible amount). Thus, no portion (or only a negligible portion) of the circularly polarized light 175 may be back-reflected by the TFTs 112 toward the polarization selective microlens assembly 150, absorbed by the TFTs 112, and/or absorbed by the black matrix 122. Accordingly, the light transmittance of the display panel 140 may be increased as compared to conventional technologies.

In some embodiments, the circularly polarized light (e.g., RHCP light) 175 output from the second PBP microlens array 153 may be configured with a collimation angle within a range of about 1° to 20°, thereby maintaining a balance between a high light transmittance and a large eye-box of the display panel 140 (e.g., an LCD panel). The collimation angle may be defined by the angle between an outmost ray of the circularly polarized light 175 and a surface normal of the second PBP microlens array 153. In some embodiments, the collimation angle may be within a range of about 5° to 15°. In some embodiments, the collimation angle may be within a range of about 1° to 2°, which may be desirable for high efficiency displays and waveguide in-coupling.

In some embodiments, the polarization selective microlens assembly 150 may also include a waveplate 155 disposed between the display panel 140 and the second PBP microlens array 153. In some embodiments, the display panel 140 may include a polarizer (e.g., a linear polarizer) 180 and an analyzer (e.g., a linear polarizer) 182 disposed at outer surfaces of the TFT array substrate 110 and the color filter substrate 120, respectively. In some embodiments, the polarizer (e.g., linear polarizer) 180 and the analyzer (e.g., linear polarizer) 182 may have orthogonal polarization axes. The waveplate 155 may be disposed between the polarizer 180 and the polarization selective microlens assembly 150. The polarizer 180 may be disposed between the waveplate 155 and the TFT array substrate 110. The display panel 140 may be disposed between the polarizer 182 and the TFT array substrate 110.

In some embodiments, the waveplate 155 may function as a QWP configured to convert the circularly polarized light (e.g., RHCP light) 175 output from the second PBP microlens array 153 as a linearly polarized light 177, while transmitting the circularly polarized light 175. The linearly polarized light 177 may be configured with a polarization direction that substantially matches with a direction of a polarization axis of the polarizer 180. For example, the linearly polarized light 177 may be a p-polarized light. In some embodiments, the waveplate 155 may function as a broadband and wide angle QWP configured to provide a quarter-wave birefringence (or quarter-wave phase retardance) across a wide spectral range (e.g., visible spectrum) and a wide incidence angle range. In some embodiments, for an achromatic and wide angular design, the waveplate 155 may include a multi-layer birefringent material (e.g., a polymer or liquid crystals) configured to provide a quarter-wave birefringence (or quarter-wave phase retardance) across a wide spectral range and a wide incidence angle range.

The polarizer (e.g., linear polarizer) 180 may be configured to substantially transmit the linearly polarized light (e.g., p-polarized light) 177 as a linearly polarized light (e.g., a p-polarized light) 179 propagating toward the TFT array substrate 110. Substantially the entire linearly polarized light (e.g., p-polarized light) 179 may propagate through the aperture of the subpixel area 119 in the TFT array substate 110 and the color filter 124 in the color filter substrate 120. Since no portion (or only a negligible portion) of the linearly polarized light (e.g., p-polarized light) 179 is back-reflected by the TFTs 112 toward the microlens assembly 150, absorbed by the TFTs 112, and/or absorbed by the black matrix 122, the light transmittance of the display panel 140 may be improved.

FIG. 1E schematically illustrates a beam spot 174 of the linearly polarized light (e.g., p-polarized light) 177 at a plane intersecting a single subpixel area 119 of the TFT array substate 110 shown in FIG. 1A, according to an embodiment of the present disclosure. In some embodiments, within the single subpixel area 119, the beam spot 174 may be configured with a size (or dimension) that is smaller than or equal to the size (or dimension) of the aperture of the subpixel area 119. For illustrative purposes, the beam spot 174 is shown with a circular shape. In some embodiments, the beam spot 174 may have other shapes. The beam spot 174 may not overlap with the TFT 112 or the wires (e.g., the data line 116 and/or the gate line 118). Thus, the linearly polarized light 177 may not be incident onto the TFT 112 and the wires, and hence may not be back-reflected by the TFT 112 and the wires toward the microlens assembly 150, and/or absorbed by the TFT 112 and/or the wires.

In some embodiments, the size (or dimension) of the beam spot 174 may also be referred to as a beam size of the linearly polarized light 177 at the plane intersecting the subpixel area 119. As shown in FIG. 1E, the beam size of the linearly polarized light 177 may be configured to be smaller than or equal to the size of the aperture of the subpixel area 119. For example, as shown in FIG. 1E, a diameter of the beam spot 174 may be smaller than or equal to a width and a length of the aperture of the subpixel area 119. The width of the aperture of the subpixel area 119 may be a dimension of the aperture along a direction parallel with the gate lines 118, and the length of the aperture of the of the subpixel area 119 may be a dimension of the aperture along a direction parallel with the data lines 116.

FIG. 1F schematically illustrates a beam spot 176 of the linearly polarized light 177 at a plane intersecting a single color filter 124 of the color filter substate 120 shown in FIG. 1A, according to an embodiment of the present disclosure. In some embodiments, the beam spot 176 may be configured with a size (or dimension) that is equal to or smaller than the size (or dimension) of the color filter 124. The beam spot 176 may not overlap with the black matrix 122. Thus, the linearly polarized light 177 may not be incident onto the black matrix 122, and hence may not be absorbed by the black matrix 122.

In some embodiments, the size (or dimension) of the beam spot 176 may also be referred to as a beam size of the linearly polarized light 177 at the plane intersecting the color filter 124. The beam size of the linearly polarized light 177 may be configured to be smaller than the size of the color filter 124. For example, as shown in FIG. 1F, the beam spot 176 of the linearly polarized light 177 may have a circular shape. A diameter of the beam spot 176 may be smaller than a width and a length of the color filter 124. The width of the color filter 124 may be a dimension along a direction parallel with the gate lines 118, and the length of the color filter 124 may be a dimension along a direction parallel with the data lines 116.

In some embodiments, the beam spot 176 of the linearly polarized light 177 at a plane intersecting the color filter 124 may be configured to have a size (or dimension) that is equal to or smaller than the size (or dimension) of the beam spot 174 of the linearly polarized light 177 at a plane intersecting the aperture of the subpixel areas 119. Referring to FIGS. 1E and 1F, the size of the beam spot 176 shown in FIG. 1F may be smaller than the size of the beam spot 174 shown in FIG. 1E. For example, the diameter of the beam spot 176 may be configured to be smaller than the diameter of the beam spot 176.

FIG. 1G schematically illustrates a y-z sectional of a portion of a display device 190, according to an embodiment of the present disclosure. The display device 190 may include elements, structures, and/or functions that are the same as or similar to those included in the display device 100 shown in FIG. 1A. Descriptions of the same or similar elements, structures, and/or functions can refer to the above descriptions rendered in connection with FIG. 1A. The display device 190 may include the backlight unit 160 (not shown), a microlens assembly 195, and the display panel 140 arranged in an optical series. For illustrative purposes, FIG. 1G shows the display panel 140, the microlens assembly 195, and the backlight unit 160 as having flat surfaces. In some embodiments, one or more of the display panel 140, the microlens assembly 195, and the backlight unit 160 may include one or more elements having curved surfaces.

In some embodiments, the microlens assembly 195 may be polarization selective. The microlens assembly 195 may include components similar to the components included in the polarization selective microlens assembly 150 shown in FIGS. 1A-1F. For example, the microlens assembly 195 may include the first polarization selective microlens array (e.g., first PBP microlens array) 151, the second polarization selective microlens array (e.g., second PBP microlens array) 153, and the waveplate 155 arranged in an optical series. In some embodiments, the microlens assembly 195 may further include a first polarizer 157 disposed between the waveplate 155 and the display panel 140, and a second polarizer 159 disposed between the first polarizer 157 and the display panel 140. The combination of the first polarizer 157 and the second polarizer 159 may be configured to reduce a leakage of a light having an undesirable polarization.

In some embodiments, the first polarizer 157 may be a linear reflective polarizer configured to substantially reflect a linearly polarized light having a predetermined polarization, and substantially transmit a linearly polarized light having a polarization orthogonal to the predetermined polarization. In some embodiments, the second polarizer 159 may be a linear absorption polarizer configured to substantially transmit a linearly polarized light having a predetermined polarization, and substantially block, via absorption, a linearly polarized light having a polarization direction orthogonal to the predetermined polarization. Thus, the combination of the first polarizer 157 and the second polarizer 159 may substantially transmit a linearly polarized light with a desirable polarization, and substantially block (via absorption) a linearly polarized light with an orthogonal polarization, thereby suppressing the ghost images caused by the linearly polarized light with the orthogonal polarization.

FIG. 1H illustrates an optical path of the backlight 171 in the display device 190, according to an embodiment of the present disclosure. For discussion purposes, FIG. 1H shows an optical path of the backlight 171 in a portion of the display device 190 corresponding to a single subpixel area 119. Optical paths of the backlight 171 in the entire display device 190 may be substantially the same as that shown in FIG. 1H. As shown in FIG. 1H, the optical path of the backlight 171 propagating through the first PBP microlens array 151, the second PBP microlens array 153, and the waveplate 155 may be similar to that shown in FIG. 1D.

In some embodiments, as shown in FIG. 1H, the light 175 output from the second PBP microlens array 153 may include a desirable component (e.g., an RHCP component) and an undesirable component (e.g., an LHCP component). The waveplate 155 may be configured to convert the light 175 to the light 177. The light 177 may propagate toward the first polarizer (e.g., linear reflective polarizer) 157. The light 177 may include a desirable component (e.g., a p-polarized component) and an undesirable component (e.g., an s-polarized component). The first polarizer 157 may be configured to substantially transmit the desirable component (e.g., p-polarized component) of the light 177 as a p-polarized light 181 toward the second polarizer (e.g., linear absorption polarizer) 159, and substantially reflect the undesirable component (e.g., s-polarized component) of the light 177 as an s-polarized light (not shown). For example, the first polarizer 157 may transform the light 177 as a light 181 propagating toward the second polarizer (e.g., linear absorption polarizer) 159. In some embodiments, the light 181 may also include a desirable component (e.g., a p-polarized component transmitted by the first polarizer 157) and an undesirable component (e.g., an s-polarized component transmitted by the first polarizer 157).

The second polarizer 159 may be configured to substantially transmit the desirable component (e.g., p-polarized component) of the light 181 as a linearly polarized light (e.g., a p-polarized light) 183, and substantially block, via absorption, the undesirable component (e.g., s-polarized component) of the light 181. Thus, a leakage of the undesirable component (e.g., LHCP component) output from the second PBP microlens array 153 may be reduced by the first polarizer 157 and the second polarizer 159. Accordingly, a ghost image caused by the light leakage may be suppressed. Substantially the entire linearly polarized light (e.g., p-polarized light) 183 may propagate through the aperture of the subpixel area 119 in the TFT array substate 110 and the color filter 124 in the color filter substrate 120. No portion (or only a negligible portion) of the linearly polarized light 183 may be incident onto the TFTs 112 and/or the black matrix 122, and be back-reflected by the TFTs 112 toward the microlens assembly 195, absorbed by the TFTs 112, and/or absorbed by the black matrix 122.

Referring to FIG. 1G and FIG. 1H, in some embodiments, the second polarizer 159 shown in FIG. 1H may also function as the polarizer 180 included in the display panel 140 shown in FIG. 1G. The second polarizer 159 and the analyzer 182 shown in FIG. 1H may have orthogonal polarization axes. In some embodiments, the first polarizer 157 shown in FIG. 1H may be omitted. In some embodiments, a combination of the waveplate 155, the first polarizer 157, and the second polarizer 159 may be replaced by a combination of a circular reflective polarizer, the waveplate 155, and the second polarizer 159.

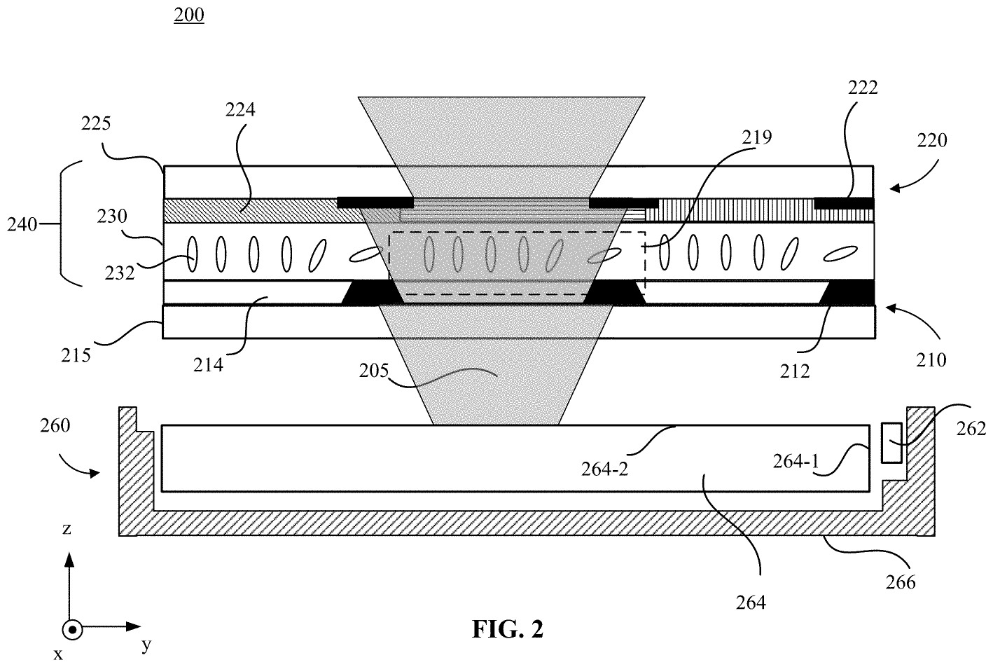

FIG. 2 schematically illustrates an optical path of a backlight 205 in a conventional display device 200. As shown in FIG. 2, the conventional display device 200 may include a backlight unit 260 and a display panel 240. The backlight unit 260 may include a backlight source assembly 262, a light guide plate 264, and a back frame 266. The light guide plate 264 may include a light incident surface 264-1 and a light output surface 264-2. The display panel 240 may include a TFT array substrate 210 and a color filter substrate 220. The TFT array substrate 210 may include a first substrate 215 and a plurality of subpixel areas 219 formed on a surface of the first substrate 215. The subpixel areas 219 may be defined by wires similar to the gate lines 118 and the data lines 116. Within each subpixel area 219, there may be a subpixel electrode 214, a TFT 212, and portions of the corresponding wires. The color filter substrate 220 may be provided at a surface of a second substrate 225 facing the first substrate 215. The color filter substrate 220 may include a plurality of color filters 224 and a black matrix 222. The display panel 240 may include an LC layer 230 including LC molecules 232. The LC layer 230 may be disposed between the TFT array substrate 210 and the color filter substrate 220. The conventional display device 200 may not include the microlens assembly 150 shown in FIG. 1A. In the conventional display device 200, the display panel 240 may be directly coupled to the backlight unit 260. The backlight unit 260 may emit a backlight 205 for illuminating the display panel 240.

For illustrative purposes, FIG. 2 shows an optical path of the backlight 205 in a portion of the display device 200 corresponding to a single subpixel area 219. Optical paths of the backlight 205 in corresponding to other subpixel areas 219 in the rest of the display device 200 may be substantially the same as that shown in FIG. 2. As shown in FIG. 2, the backlight unit 260 may output the diffused backlight 205 toward the display panel 240. A portion of the backlight 205 may be incident onto the TFTs 212 and the black matrix 222. Thus, a portion of the diffused backlight 205 may be reflected and/or absorbed by the TFTs 212, and absorbed by the black matrix 122. Thus, the light transmittance of the display panel 240 may be decreased, and the power efficiency of the display device 200 may be reduced. The decrease of the light transmittance of the display panel 240 may become more severe for LCD panels with a high pixel density (or high pixel per inch (“ppi”), high resolution), e.g., LCD panels with over 1000 ppi.

Compared to the conventional display device 200 shown in FIG. 2, the display device 100 or 190 of the present disclosure as shown in FIGS. 1A-1H may include the microlens assembly 150 or 195 disposed between the display panel 140 and the backlight unit 160. The microlens assembly 150 or 195 may be polarization selective. The microlens assembly 150 or 195 may transform the diffused backlight 171 into a focused light 177 or 183 that propagates through the apertures of the subpixel areas 119 in the TFT array substate 110 and the color filters 124 in the color filter substrate 120, with no portion of (or only a negligible portion of) the light 177 or 183 being back-reflected by the TFTs 112, being absorbed by the TFTs 112, and/or being absorbed by the black matrix 122. Thus, compared to the conventional display device 200 shown in FIG. 2, the disclosed display device 100 or 190 shown in FIGS. 1A-1H provides an enhanced light transmittance and an increased power efficiency. The increase in the light transmittance and the power efficiency may become more prominent when the display panel 140 is an LCD panel having a high pixel density (or high ppi, or high resolution), e.g., an LCD panel with over 100 or 1900 ppi.

In the display device 100 or 190 shown in FIGS. 1A-1H, the first microlens array 151 and the second microlens array 153 are shown to be spherical microlens arrays, which are for illustrative purposes. In some embodiments, each of the first microlens array 151 and the second microlens array 153 may be a spherical microlens array, an aspherical microlens array, a cylindrical microlens array, or a freeform microlens array, etc. Each of the first microlens 152 and the second microlens 154 may be a spherical microlens, an aspherical microlens, a cylindrical microlens, or a freeform microlens, etc.

In the display device 100 or 190 shown in FIGS. 1A-1H, the microlens assembly 150 or 195 is shown to include two microlens arrays stacked in parallel: the first microlens array 151 configured to substantially collimate the backlight into a first polarized light, and the second microlens array 153 configured to focus the first polarized light as a second polarized light propagating through apertures of the subpixel areas. This configuration is for illustrative purposes. In some embodiments, the microlens assembly 150 or 195 may include more than two microlens arrays arranged in parallel. Each microlens array may be a spherical microlens array, an aspherical microlens array, a cylindrical microlens array, or a freeform microlens array, etc. In some embodiments, the more than two microlens arrays may include at least one freeform microlens array, which may enable a high collimation of the backlight output from the second microlens array 153, e.g., within a range of about 10 to 2°.

The microlens arrays included in the microlens assembly 150 or 195 may be fabricated using any suitable fabrication method, such as holographic interference, laser direct writing, ink-jet printing, or various other forms of lithography. For example, in some embodiments, a photo-alignment material may be disposed at the display panel 140 and optically patterned (e.g., via a polarization interference) to form an alignment layer corresponding to a desirable microlens array. A polymerizable LC material may be disposed on the alignment layer, and aligned by the alignment layer to form the desirable microlens array. The LC material may be further polymerized to stabilize the microlens array. In some embodiments, a birefringent photo-refractive holographic material other than the LC material may be disposed at the display panel 140 and optically patterned (e.g., via a polarization interference) to form a desirable microlens array directly. The above-mentioned steps may be repeated to fabricate a plurality of microlens arrays on the display panel 140. The microlens array may be fabricated “on-cell” with an alignment offset (or alignment displacement) of less than or equal to 2 μm (or 1 μm, or 100 nm) with respect to the array of apertures (or subpixel electrodes 114) of the subpixels 119. In some embodiments, two-photon polarization laser writing may be used to fabricate a freeform microlens array.

In the display device 100 or 190 shown in FIGS. 1A-1H, the TFTs 112 and the color filters 124 are disposed at different sides of the LC layer 130. This configuration is for illustrative purposes, and other suitable configurations may be used. In some embodiments, the TFTs 112 and the color filters 124 may be disposed at the same side of the LC layer 130, e.g., both of the TFTs 112 and the color filters 124 may be disposed at the first substate 115 or the second substate 125. In other words, the TFT array substate 110 or the color filter substate 120 may include both of the TFTs 112 and the color filters 124.

The principle described above for increasing the light transmittance and power efficiency of the display device 100 or 190 via the polarization selective microlens assembly 150 or 195 may be applicable to any suitable display device including a non-emissive display panel and a backlight unit, and is not limited to the display device 100 or 190 shown in FIGS. 1A-1H. The non-emissive display panel may be any suitable non-emissive display panel, such as any suitable LCD panel, any suitable LCoS display panel, etc. The non-emissive display panel may include any suitable elements and structures arranged in any suitable configurations. The LCD panel and the LCoS display panel may operate in any suitable operation mode, such as a twisted-nematic (“TN”) mode, an in-plane-switching (“IPS”) mode, a fringe field switching (“FFS”) mode, a vertical alignment (“VA”) mode, a multidomain vertical alignment (“MVA”) mode, or a blue phase mode, etc. The backlight unit may be any suitable backlight units, such as an edge-lit backlight unit, or a direct-lit backlight unit, etc.

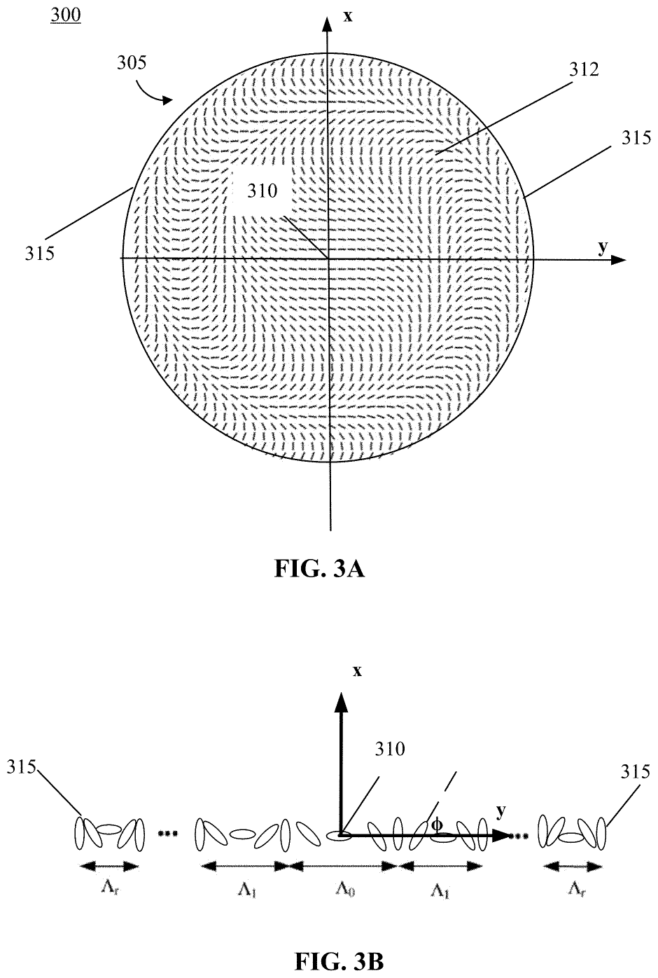

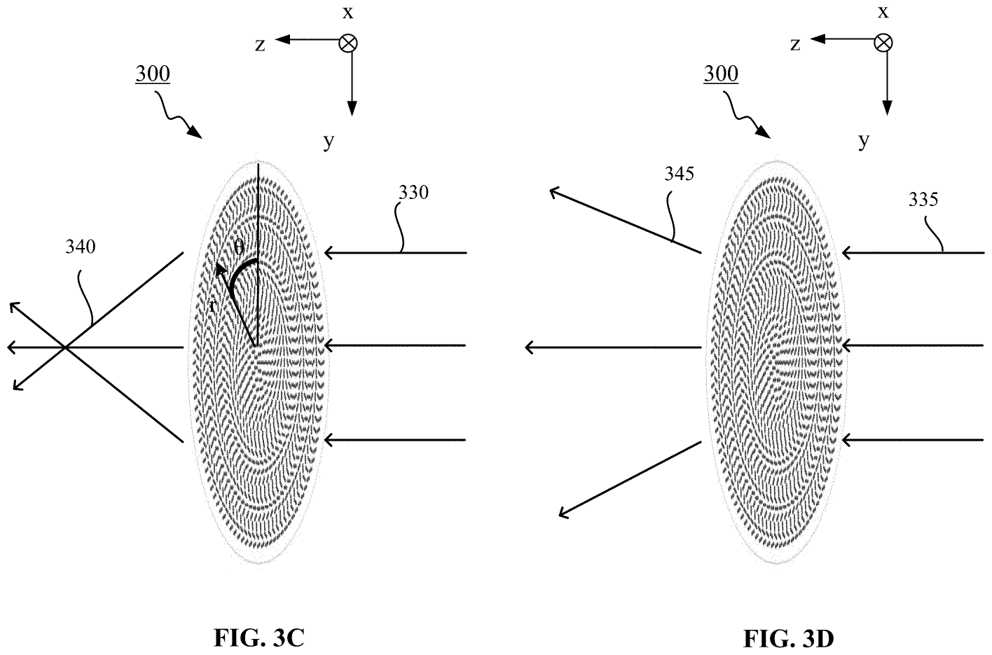

FIGS. 3A-3D illustrate a PBP microlens 300, according to an embodiment of the present disclosure. The PBP microlens 300 may be an embodiment of the microlens 152 or 154 included in the first PBP microlens array 151 or the second PBP microlens array 153 shown in FIG. 1A. In some embodiments, the PBP microlens 300 may include a birefringent film 305. An optic axis of the birefringent film 305 may be configured with an in-plane orientation pattern, in which the orientation of the optic axis may continuously vary in at least two opposite in-plane directions (e.g., a plurality of opposite radial directions) from a center of the in-plane orientation pattern to two opposite peripheries of the in-plane orientation pattern with a varying pitch (e.g., decreasing from center to peripheries). In some embodiments, the birefringent film 305 may include optical anisotropic molecules 312.

FIG. 3A schematically illustrates an x-y sectional view of an in-plane orientation pattern of optical anisotropic molecules 312 in the birefringent film 305 of the PBP microlens 300, according to an embodiment of the present disclosure. FIG. 3B illustrates a section of the in-plane orientation pattern taken along a y-axis in the birefringent film 305 of the PBP microlens 300 shown in FIG. 3A, according to an embodiment of the present disclosure. For discussion purposes, in FIGS. 3A and 3B, the birefringent film 305 may include an LC material, and rod-like LC molecules 312 are used as examples of the optically anisotropic molecules 312 of the birefringent film 305. The rod-like LC molecule 312 may have a longitudinal direction (or a length direction) and a lateral direction (or a width direction). The longitudinal direction of the LC molecule 312 may be referred to as a director of the LC molecule 312 or an LC director. An orientation of the LC director may determine a local optic axis orientation or an orientation of the optic axis at a local point of the birefringent film 305. The term “optic axis” may refer to a direction in a crystal. A light propagating in the optic axis direction may not experience birefringence (or double refraction). An optic axis may be a direction rather than a single line: lights propagating in directions parallel to that direction may experience no birefringence. The local optic axis may refer to an optic axis within a predetermined region of a crystal.

As shown in FIG. 3A, the LC molecules 312 located in close proximity to or at a surface (e.g., at least one of a first surface or a second surface) of the birefringent film 305 may be configured with an in-plane orientation pattern having a varying pitch in at least two opposite in-plane directions (e.g., a plurality of radial directions) from a lens center 310 to opposite lens peripheries 315. For example, orientations of LC directors of LC molecules 312 located in close proximity to or at the surface of the birefringent film 305 may exhibit a continuously rotation in at least two opposite in-plane directions from the lens center 310 to the opposite lens peripheries 315 with a varying pitch Λ. The orientations of the LC directors may exhibit a rotation in a same rotation direction (e.g., clockwise, or counter-clockwise) from the lens center 310 to the opposite lens peripheries 315. A pitch Λ of the in-plane orientation pattern may be defined as a distance in the in-plane direction (e.g., a radial direction) over which the orientation of the LC director (or an azimuthal angle ϕ of the LC molecule 312) changes by a predetermined angle (e.g., 180°) from a predetermined initial state. The pitch Λ of the in-plane orientation pattern may also be referred to as an in-plane pitch of the in-plane orientation pattern. As shown in FIG. 3B, according to the LC director field along the y-axis direction, the pitch Λ may be a function of the distance from the lens center 310. The pitch Λ may monotonically decrease from the lens center 310 to the lens peripheries 315 in the at least two opposite in-plane directions (e.g., a plurality of opposite radial directions) in the x-y plane, e.g., Λ₀>Λ₁> . . . >Λᵣ. Λ₀ is the pitch at a central region of the PBP microlens 300, which may be the largest. The pitch Λᵣ is the pitch at an edge region (e.g., periphery 315) of the PBP microlens 300, which may be the smallest. In some embodiments, the azimuthal angle ϕ of the LC molecule 312 may change in proportional to the distance from the lens center 310 to a local point of the birefringent film 305 at which the LC molecule 312 is located. For example, the azimuthal angle ϕ of the LC molecule 312 may change according to an equation of

$$ϕ = \frac{π {r}^{2}}{2 f λ} ,$$

where ϕ is the azimuthal angle of the LC molecule 312 at a local point of the birefringent film 305, r is a distance from the lens center 310 to the local point in the lens plane, f is a focal distance of the PBP microlens 300, and λ is a designed operation wavelength of the PBP microlens 300. In some embodiments, in a volume of the birefringent film 305, along the thickness direction (e.g., the z-axis direction) of the birefringent film 305, the LC directors (or the azimuth angles ϕ) of the LC molecules 312 may remain in the same orientation (or value) from the first surface to the second surface of the birefringent film 305. In some embodiments, a twist structure may be introduced along the thickness direction of the birefringent film 305 and may be compensated for by its mirror twist structure, which may enable the PBP microlens 300 to have an achromatic performance.

FIGS. 3C and 3D illustrate polarization selective focusing/defocusing of the PBP microlens 300, according to an embodiment of the present disclosure. The PBP microlens 300 may be a passive PBP microlens. A passive PBP lens may have, or may be configurable to operate in, two optical states, i.e., a focusing (or converging) state and a defocusing (or diverging) state. The optical state of the passive PBP lens may depend on the handedness of a circularly polarized input light and the rotation direction of the LC directors in the at least two opposite in-plane directions from the lens center 310 to the opposite lens peripheries 315. For example, as shown in FIG. 3C, the PBP microlens 300 may operate in the focusing state (or the converging state) for an RHCP light 330 having a wavelength in a predetermined wavelength range. As shown in FIG. 3D, the PBP microlens 300 may operate in the defocusing state (or the diverging state) for an LHCP light 335 having a wavelength in a predetermined wavelength range. In addition, the PBP microlens 300 may reverse the handedness of a circularly polarized light transmitted therethrough in addition to focusing/defocusing the light. For example, as shown in FIG. 3C, the PBP microlens 300 may focus the RHCP light 330 as an LHCP light 340. As shown in FIG. 3D, the PBP microlens 300 may defocus the LHCP light 335 as an RHCP light 345. In some embodiments, the PBP microlens 300 may be indirectly switchable between the positive state and the negative state when a handedness of an input light is changed through an external polarization switch.

The PBP microlens 300 based on LCs shown in FIGS. 3A-3D are for illustrative purposes. In some embodiments, the PBP microlens may be based on sub-wavelength structures, a birefringent material (e.g., LCs), a photo-refractive holographic material, or any combination thereof.

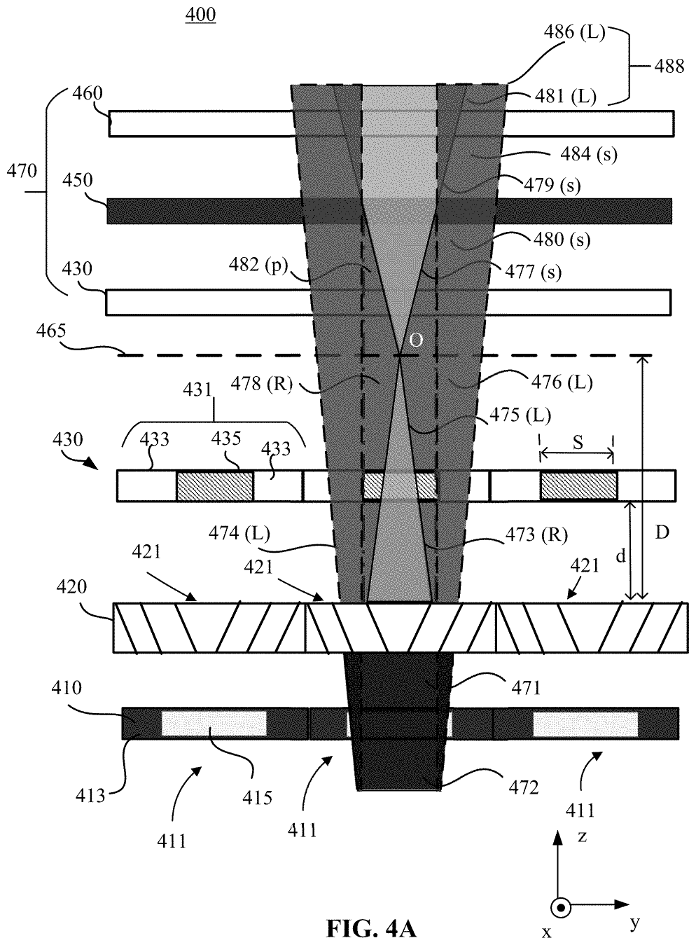

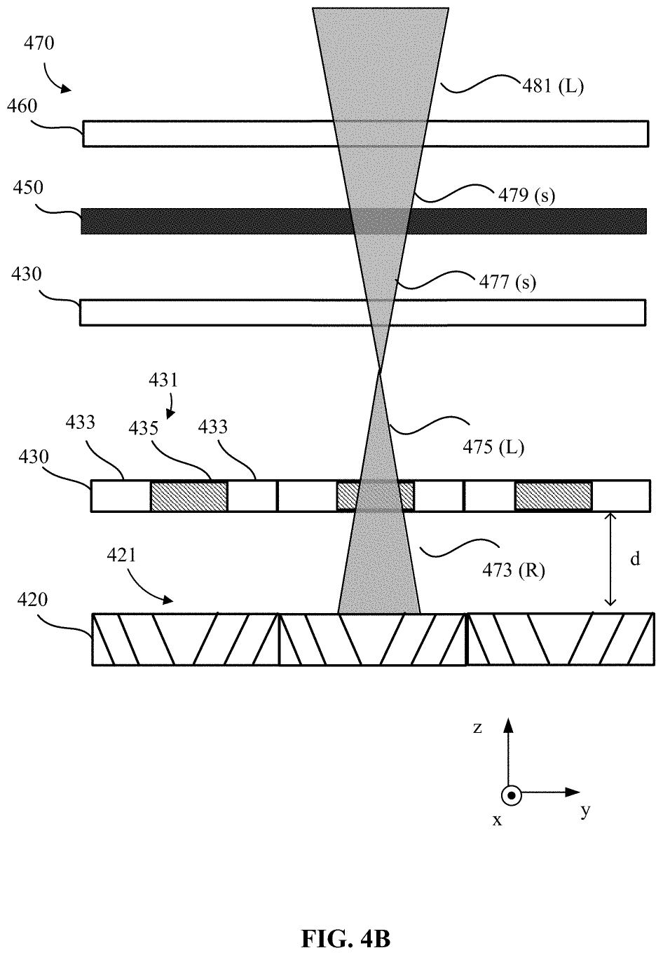

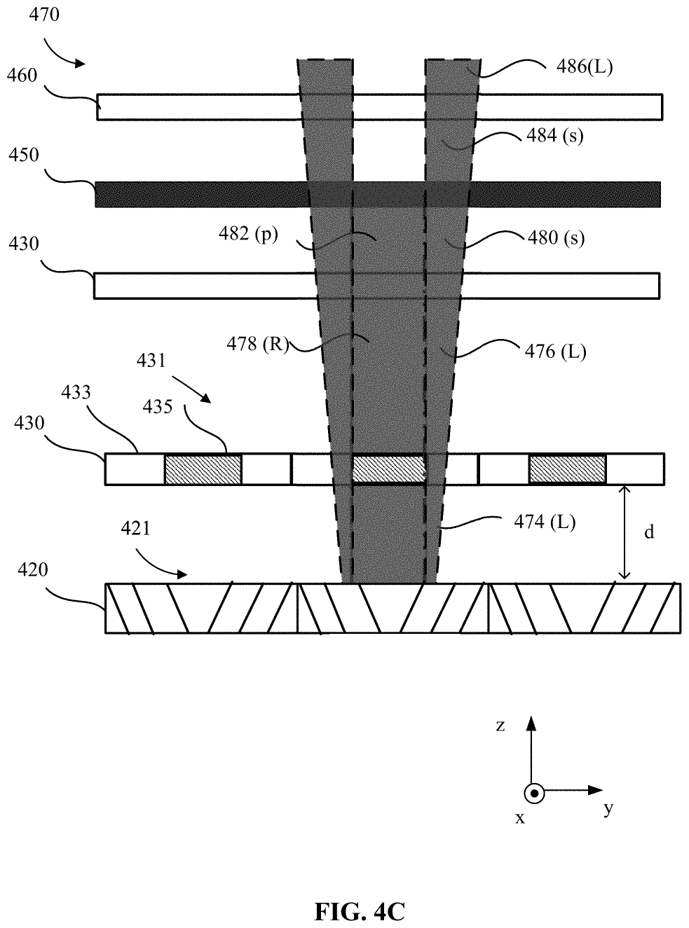

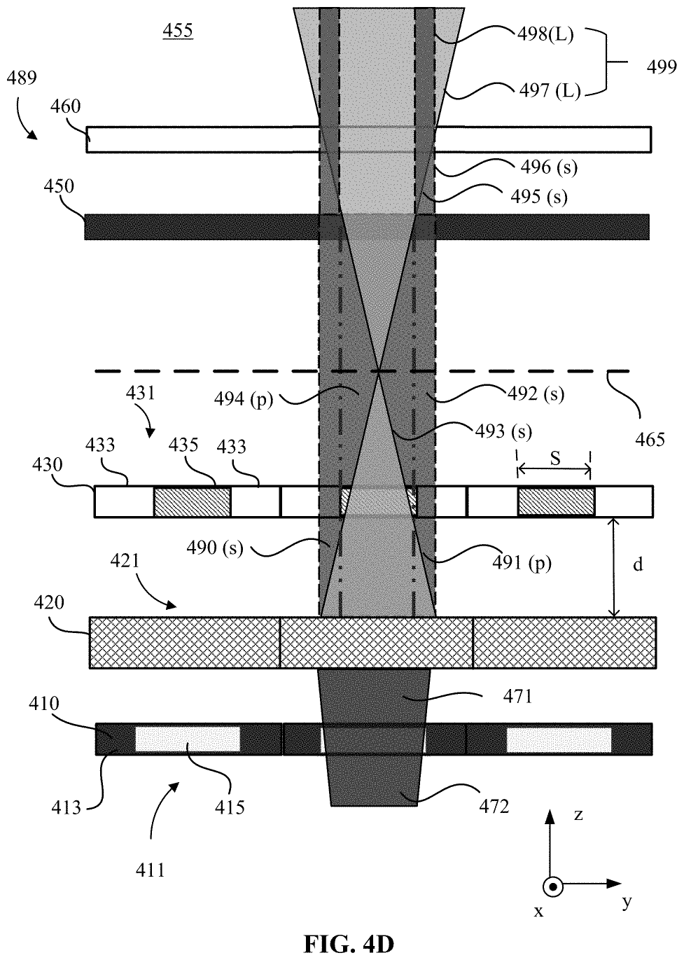

FIG. 4A schematically illustrates a y-z sectional view of a display device 400, according to an embodiment of the present disclosure. The display device 400 may be an emissive display device. In some embodiments, the display device 400 may include a plurality of light-emitting diodes. For example, the display device 400 may be an OLED display device, an LED display device, a μOLED display device, an mLED display device, or a μLED display device, etc. As shown in FIG. 4A, the display device 400 may include a display panel 410, a microlens array 420, a polarization converter 430, a first waveplate 440, a polarizer 450, and a second waveplate 460 arranged in an optical series. For illustrative purposes, in FIG. 4A, the display panel 410, the microlens array 420, the polarization converter 430, the first waveplate 440, the polarizer 450, and the second waveplate 460 are drawn as having flat surfaces. In some embodiments, one or more of the display panel 410, the microlens array 420, the polarization converter 430, the first waveplate 440, the polarizer 450, and the second waveplate 460 may have curved surfaces. The display device 400 may also include other elements that are not shown in FIG. 4A. In some embodiments, one or more components shown in FIG. 4A may be omitted.

The display panel 410 may include a self-emissive panel that includes a plurality of light-emitting elements (e.g., light-emitting chips) 411 arranged in an array. The light-emitting elements 411 may function as subpixels (also referred to as 411 for discussion purposes). For example, the display panel 410 may include an OLED display panel, a μOLED display panel, an mLED display panel, or a pLED display panel, etc., in which OLED chips, μOLED chips, mLED chips, or μLED chips, etc., may function as subpixels 411. In some embodiments, the light-emitting elements 411 may include red (“R”), green (“G”), and blue (“B”) light-emitting elements. In other words, the display panel 410 may include red (“R”), green (“G”), and blue (“B”) subpixels 411. In some embodiments, an elementary pixel may include three subpixels, e.g., red (“R”), green (“G”), and blue (“B”) subpixels. The light-emitting element 411 may include a light-emitting area 415 and a non-emitting area 413. In some embodiments, the non-emitting area 413 may surround or define the light-emitting area 415. In some embodiments, the display panel 410 may include a light shielding material, such as a black matrix (not shown) configured to cover (or conceal) the non-emitting area 413 from being perceived by a viewer of the display device 400.

In some embodiments, the microlens array 420 may be polarization selective. The microlens array 420 may be disposed between the display panel 410 and the polarization converter 430. In some embodiments, the polarization converter 430 may be a patterned polarization converter. In some embodiments, the microlens array 420 is shown as spaced apart from the display panel 410 by a gap. In some embodiments, the microlens array 420 and the display panel 410 may be stacked without a gap. In other words, the microlens array 420 may be directly disposed on the display panel 410 without a gap. In such an embodiment, the crosstalk between neighboring subpixels 411 may be suppressed. The microlens array 420 may include a plurality of microlenses 421 arranged in an array. FIG. 4A shows three microlenses 421 for illustrative purposes. In some embodiments, the microlenses 421 may be polarization selective microlenses. The microlenses 421 may be substantially aligned with the light-emitting elements (or subpixels) 411 in the display panel 410. In some embodiments, an alignment displacement (or an alignment offset) between the array of the light-emitting elements (or subpixels) 411 and the microlens array 420 may be less than or equal to 2 μm. In some embodiments, an alignment displacement (or an alignment offset) between the array of the light-emitting elements (or subpixels) 411 and the microlens array 420 may be less than or equal to 1 μm. In some embodiments, an alignment displacement (or an alignment offset) between the array of the light-emitting elements (or subpixels) 411 and the microlens array 420 may be less than or equal to 100 nm.

In some embodiments, the microlens array 420 may be circular polarization selective. In some embodiments, the microlens array 420 may be a transmissive polarization volume hologram (“T-PVH”) microlens array, and the microlenses 421 may be T-PVH microlenses. In some embodiments, the microlens array 420 may be configured to modulate a circularly polarized light via Bragg diffraction. In some embodiments, the microlens array 420 may include at least one of sub-wavelength structures (e.g., a metamaterial), a birefringent material (e.g., an LC material), or a photo-refractive holographic material (e.g., an amorphous polymer). In some embodiments, the microlens array 420 may be a liquid crystal polymer (“LCP”) microlens array. In other words, the microlens array 420 may be an LCP-based T-PVH microlens array. The microlens array 420 or microlenses 421 may be fabricated using various methods, such as holographic interference, laser direct writing, ink-jet printing, or various other forms of lithography. Thus, a “hologram” as described herein is not limited to the fabrication by holographic interference, or “holography.”

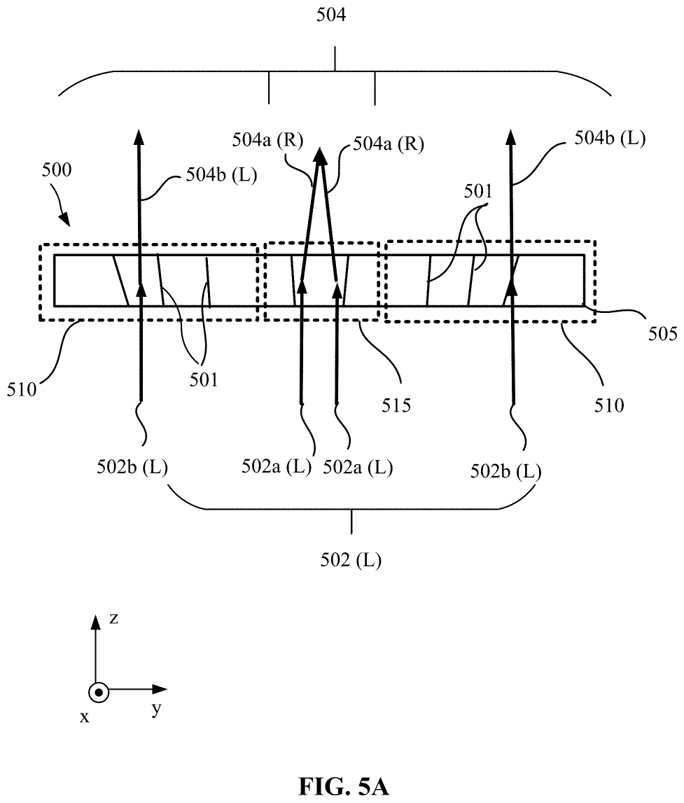

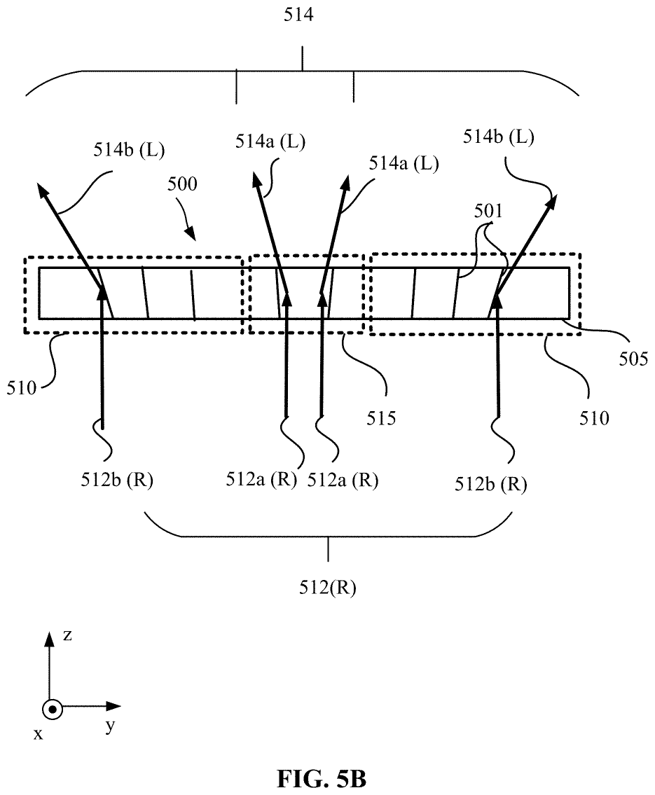

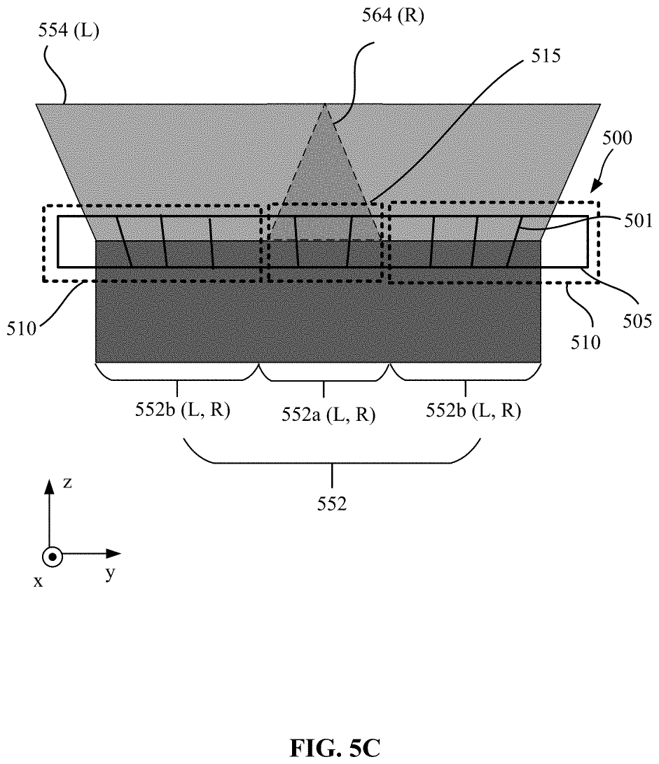

FIG. 5A illustrates a y-z sectional view of a T-PVH microlens 500, according to an embodiment of the present disclosure. The T-PVH microlens 500 may be an embodiment of the microlens lens 421 shown in FIG. 4A, when the microlens lens 421 is circular polarization selective. In some embodiments, the T-PVH microlens 500 may include at least one of sub-wavelength structures (e.g., a metamaterial), a birefringent material (e.g., an LC material), or a photo-refractive holographic material (e.g., an amorphous polymer). In some embodiments, the T-PVH microlens 500 may include a birefringent film 505 that includes optical anisotropic molecules (e.g., LC molecules). LC molecules located in close proximity to or at a surface of the birefringent film 505 of the T-PVH microlens 500 may be configured with an in-plane orientation pattern that is similar to the x-y sectional view of the in-plane orientations of the LC molecules 312 in the birefringent film 305 of the PBP microlens 300 shown in FIGS. 3A and 3B.

In some embodiments, within a volume of the birefringent film 505 of the T-PVH microlens 500, the LC molecules may be arranged in a plurality of helical structures. The orientations of the LC directors of the LC molecules in a single helical structure may exhibit a continuous rotation in a predetermined rotation direction along a helical axis. In some embodiments, the helical axis of the helical structures may be substantially perpendicular to the surface of the birefringent film 505. In other words, the helical axes of the helical structures may extend in a thickness direction of the birefringent film 505. The LC molecules from the plurality of helical structures having a same orientation of the LC directors may form a series of parallel refractive index planes 501 periodically distributed within the volume of the birefringent film 505. Different series of parallel refractive index planes 501 may be formed by the LC molecules having different orientations. In the same series of parallel and periodically distributed refractive index planes, the LC molecules may have the same orientation and the refractive index may be the same. Different series of refractive index planes 501 may correspond to different refractive indices. In some embodiments, the series of parallel refractive index planes 501 may be slanted with respect to the surface of the birefringent film 505.

When the number of the refractive index planes (or the thickness of the birefringent film 505) increases to a sufficient value, Bragg diffraction may be established according to the principles of volume gratings. The periodically distributed refractive index planes may also be referred to as Bragg planes 501. The different series of Bragg planes 501 formed within the volume of the birefringent film 505 may produce a varying refractive index profile that is periodically distributed in the volume of the birefringent film 505. In some embodiments, the T-PVH microlens 500 may modulate (e.g., diffract) an input light satisfying a Bragg condition through Bragg diffraction.

In the embodiment shown in FIG. 5A, the T-PVH microlens 500 may include a central portion 515 and a periphery portion 510 surrounding the central portion 515. For example, when the T-PVH microlens 500 has a circular aperture, the central portion 515 may be a central portion of the circular aperture, and the periphery portion 510 may be the rest of the circular aperture surrounding the central portion 515. In the embodiment shown in FIG. 5A, the Bragg planes 501 may be increasingly slanted (with respect to a normal of a surface of the T-PVH microlens 500) from the central portion 515 to the periphery portion 510 in at least two opposite radial directions of the T-PVH microlens 500, e.g., the two opposite radial directions along the y axis. In addition, referring to FIG. 3B and FIG. 5A, the in-plane pitch Λ of the in-plane orientation pattern of the T-PVH microlens 500 may monotonically decrease from a lens center (or the central portion 515) to lens peripheries (or the periphery portion 510) in at least two opposite radial directions of the T-PVH microlens 500, e.g., the two opposite radial directions along the y axis. In other words, the central portion 515 of the T-PVH microlens 500 may have a relatively large in-plane pitch (e.g., larger than or equal to 1 μm), and the periphery portion 510 of the T-PVH microlens 500 may have a relatively small in-plane pitch (e.g., smaller than 1 μm).

In some embodiments, the in-plane pitch at the central portion 515 of the T-PVH microlens 500 may be configured to be larger than or equal to 1 μm. The central portion 515 of the T-PVH microlens 500 may function similar to a PBP microlens (similar to that shown in FIGS. 3C and 3D). For example, the central portion 515 of the T-PVH microlens 500 may focus (or converge) a circularly polarized light with a predetermined handedness, and defocus (or diverge) a circularly polarized light with a handedness that is opposite to the predetermined handedness. The central portion 515 of the T-PVH microlens 500 may also reverse the handednesses of the focused light and the defocused light. In some embodiments, the in-plane pitch at the periphery portion 510 of the T-PVH microlens 500 may be configured to be smaller than 1 μm. The periphery portion 510 of the T-PVH microlens 500 may function as a T-PVH grating with an optical power. The periphery portion 510 of the T-PVH microlens 500 may substantially forwardly diffract a circularly polarized light with a predetermined handedness, and substantially transmit, with negligible diffraction, a circularly polarized light with a handedness that is opposite to the predetermined handedness. The periphery portion 510 of the T-PVH microlens 500 may reverse a handedness of the diffracted light, and substantially maintain a handedness of the transmitted light. In addition, the orientations of the Bragg planes 501 within the volume of the T-PVH microlens 500 are configured, such that the periphery portion 510 of the T-PVH microlens 500 may diverge, via forward diffraction, the circularly polarized light with the predetermined handedness.

FIGS. 5A-5C illustrate polarization selective diffractions of the T-PVH microlens 500, according to an embodiment of the present disclosure. In FIGS. 5A-5C, “R” denotes an RHCP light, “L” denotes an LHCP light. The handednesses of the lights shown in FIGS. 5A-5C are for illustrative purposes. In other embodiments, the handednesses may be reversed or switched (e.g., R switched to L, and L switched to R) from those shown in FIGS. 5A-5C. In the embodiment shown in FIGS. 5A and 5B, the central portion 515 of the T-PVH microlens 500 may function as a PBP microlens configured to focus (or converge) a circularly polarized light with a first handedness (e.g., an LHCP light), and defocus (or diverge) a circularly polarized light with a second handedness that is opposite to the first handedness (e.g., an RHCP light). The periphery portion 510 of the T-PVH microlens 500 may function as a T-PVH grating configured to substantially forwardly diffract a circularly polarized light with the second handedness (e.g., an RHCP light), and substantially transmit, with negligible diffraction, a circularly polarized light with the first handedness (e.g., an LHCP light). In addition, the orientations of the Bragg planes 501 within the volume of the T-PVH microlens 500 are configured, such that the periphery portion 510 of the T-PVH microlens 500 may diverge, via forward diffraction, the circularly polarized light with the second handedness (e.g., the RHCP light)

In FIG. 5A, a circularly polarized light 502 with the first handedness (e.g., an LHCP light 502) may be incident onto the T-PVH microlens 500. For discussion purposes, the LHCP light 502 may be a substantially collimated light, e.g., a fully collimated light or a non-fully collimated light with a negligible divergence. The LHCP light 502 may include a central portion 502a incident onto the central portion 515 of the T-PVH microlens 500, and a periphery portion 502b incident onto the periphery portion 510 of the T-PVH microlens 500. The central portion 515 of the T-PVH microlens 500 may be configured to focus (or converge) the central portion 502a of the LHCP light 502 as a focused RHCP light 504a. The periphery portion 510 of the T-PVH microlens 500 may be configured to substantially transmit, with negligible diffraction, the periphery portion 502b of the LHCP light 502 as a substantially collimated LHCP light 504b.

Thus, for the LHCP light 502 incident onto the T-PVH microlens 500, the T-PVH microlens 500 may output the focused light (e.g., RHCP light) 504a from the central portion 515 of the T-PVH microlens 500, and the substantially collimated periphery light (e.g., LHCP light) 504b from the periphery portion 510 of the T-PVH microlens 500. In some embodiments, the focused light (e.g., RHCP light) 504a and the substantially collimated periphery light (e.g., LHCP light) 504b may be combined to be visually observed as a light 504.

In FIG. 5B, a circularly polarized light 512 with the second handedness (e.g., an RHCP light 512) may be incident onto the T-PVH microlens 500. For discussion purposes, the RHCP light 512 may be a substantially collimated light, e.g., a fully collimated light or a non-fully collimated light with a negligible divergence. The RHCP light 512 may include a central portion 512a incident onto the central portion 515 of the T-PVH microlens 500, and a periphery portion 512b incident onto the periphery portion 510 of the T-PVH microlens 500. In the embodiment shown in FIG. 5B, the central portion 515 of the T-PVH microlens 500 may be configured to forwardly diffract and defocus (or diverge) the central portion 512a of the LHCP light 512 as a defocused LHCP light 514a. The periphery portion 510 of the T-PVH microlens 500 may be configured to forwardly diffract and defocus (or diverge) the periphery portion 512b of the LHCP light 512 as an LHCP light 514b.

Thus, for the RHCP light 512 incident onto the T-PVH microlens 500, the T-PVH microlens 500 may output the defocused LHCP light 514a from the central portion 515 of the T-PVH microlens 500, and the defocused LHCP light 514b from the periphery portion 510 of the T-PVH microlens 500. In some embodiments, defocused LHCP light 514a and the defocused LHCP light 514b may be combined to be visually observed as a defocused LHCP light 514.

In the embodiment shown in FIG. 5C, a light 552 incident onto the T-PVH microlens 500 may include a central portion 552a incident onto the central portion 515 of the T-PVH microlens 500, and a periphery portion 552b incident onto the periphery portion 510 of the T-PVH microlens 500. Each of the central portion 552a and the periphery portion 552b may include two orthogonally circularly polarized components: a first circularly polarized component having a first handedness (e.g., left handedness or “L”), and a second circularly polarized component having a second handedness (e.g., right handedness or “R”) opposite to the first handedness. The first circularly polarized component having the first handedness (e.g., left handedness or “L”) of the light 552 includes the first circularly polarized components having the first handedness (e.g., left handedness or “L”) of the central portion 552a and the periphery portion 552b. The second circularly polarized component having the second handedness (e.g., right handedness or “R”) of the light 552 includes the second circularly polarized components having the second handedness (e.g., right handedness or “R”) of central portion 552a and the periphery portion 552b. In some embodiments, the light 552 may be an unpolarized light. In some embodiments, the light 552 may be or a linearly polarized light.

In other words, the light 552 may include two orthogonally circularly polarized components: a first circularly polarized component (e.g., an LHCP component) having a first handedness (e.g., left handedness or “L”), and a second circularly polarized component (e.g., an RHCP component) having a second handedness (e.g., right handedness or “R”) opposite to the first handedness. The first circularly polarized component (e.g., LHCP component) may include a central portion 552a (L) incident onto the central portion 515 of the T-PVH microlens 500, and a periphery portion 552b (L) incident onto the periphery portion 510 of the T-PVH microlens 500. The second circularly polarized component (e.g., RHCP component) may include a central portion 552a (R) incident onto the central portion 515 of the T-PVH microlens 500, and a periphery portion 552b (R) incident onto the periphery portion 510 of the T-PVH microlens 500.

For discussion purposes, a first portion of the light 552 is defined as the LHCP component (L) of the central portion 552a, i.e., 552a (L) (similar to the central portion 502a of the LHCP light 502 shown in FIG. 5A). A second portion of the light 552 is defined as the RHCP component (R) of the central portion 552a (i.e., 552a (R)) and the entire periphery portion 552b that includes both the LHCP component (L) (i.e., 552b (L)) and the RHCP component (R) (i.e., 552b (R)). In other words, the second portion of the light 552 is defined as a combination of the entire RHCP component (R) of the light 552 (i.e., 552a (R)) and 552b (R)), and the periphery portion of the LHCP component (L) of the light 552 (i.e., 552b (L)).

For illustrative and discussion purposes, the incident light 552 is shown in FIG. 5C and described below as a substantially collimated light. In other embodiments, the incident light 552 may be a non-collimated light. Referring to FIG. 5A-5C, the T-PVH microlens 500 may be configured to transform the first portion of the incident light 552 as a first polarized light 564 (e.g., similar to the focused RHCP light 504a shown in FIG. 5A), and transform the second portion of the incident light 552 as a second polarized light 554 (e.g., similar to a combination of the substantially collimated LHCP light 504b shown in FIG. 5A and the defocused LHCP light 514 shown in FIG. 5B). Detailed descriptions of the light propagations paths can refer to the above descriptions rendered in connection with FIGS. 5A and 5B.

In some embodiments, the first polarized light 564 and the second polarized light 554 may be orthogonally circularly polarized lights. For example, as shown in FIG. 5C, the first polarized light 564 may be an RHCP light, and the second polarized light 554 may be an LHCP light. In some embodiments, the first polarized light 564 may be a focused (or convergent) light output from the central portion 515 of the T-PVH microlens 500, and the second polarized light 554 may be a defocused (or divergent) light output from both of the central portion 515 and the periphery portion 510 of the T-PVH microlens 500. In other words, the T-PVH microlens 500 may focus (or converge) the first portion of the incident light 552 as the first polarized light 564 that is focused to a positive focal point of the T-PVH microlens 500, and defocus (or diverge) the second portion of the incident light 552 as the second polarized light 554. A positive focal point may be referred to as a focal point of a lens that is on the other side of the lens from where an object is placed, or on the light outputting side of the lens, rather than on the light input side of the lens. As the first polarized light 564 propagates in space, the first polarized light 564 may be first focused to the positive focal point of the T-PVH microlens 500, then defocused beyond the positive focal point (not shown in FIG. 5C).

In the embodiment shown in FIG. 5C, the T-PVH microlens 500 may be configured to defocus (or diverge) the second portion of the incident light 552 as the second polarized light 554, with a substantially small divergence. As noted, the configuration shown in FIG. 5C may be understood as a combination of the configurations shown in FIG. 5A and FIG. 5B. As shown in FIG. 5B, the parameters of the T-PVH microlens 500 may be configured, such that the central portion 515 of the T-PVH microlens 500 may be configured to forwardly diffract and defocus (or diverge) the central portion 512a of the LHCP light 512 as the LHCP light 514a in a substantially small diffraction angle. The periphery portion 510 of the T-PVH microlens 500 may be configured to forwardly diffract and defocus (or diverge) the periphery portion 512b of the LHCP light 512 as the LHCP light 514b in a substantially small diffraction angle.

Referring back to FIG. 4A, for an incident light (e.g., an unpolarized incident light or a linearly polarized incident light) including an RHCP component and an LHCP component, each microlens 421 included in the microlens array (e.g., T-PVH microlens array) 420 may function similar to the T-PVH microlens 500 shown in FIGS. 5A-5C. For example, each microlens 421 may be configured to transform a first portion of an incident light (that is incident onto each microlens) as a first polarized light, and transform a second portion of the incident light as a second polarized light, in a manner similar to that described above in connection with FIGS. 5A-5C. Detailed descriptions of the transformation of the light can refer to the above descriptions rendered in connection with FIGS. 5A-5C. In some embodiments, the incident light may be a substantially collimated light. In some embodiments, the first polarized light may be a focused or convergent light, and the second polarized light may be a defocused or divergent light. In some embodiments, the first polarized light and the second polarized light may be orthogonally circularly polarized lights.

The first portion and the second portion of the incident light that is incident onto each microlens may be defined in a manner similar to the first portion and the second portion of the light 552 shown in FIG. 5C. For example, in some embodiments, the first portion of the incident light may include an RHCP component (or an LHCP component) of a central portion of the incident light that is incident onto a central portion of each microlens 421. In some embodiments, the second portion of the incident light may include the LHCP component (or the RHCP component) of the central portion of the incident light, and a periphery portion (including both the RHCP component and the LHCP component) of the incident light. In other words, the second portion of the incident light may include a combination of the entire LHCP component (or the RHCP component) of the incident light and the periphery portion of the RHCP component of the incident light. The first portion of the incident light may include the central portion of the RHCP component (or LHCP component) of the incident light that is incident onto a central portion of each microlens 421.

The polarization converter 430 (which may be a patterned polarization converter) may be disposed between the microlens array 420 and the first waveplate 440. The polarization converter 430 may include a plurality of polarization converting segments 431 arranged in an array. The polarization converting segments 431 may be substantially aligned with the microlenses 421, and substantially aligned with the light-emitting elements (or subpixels) 411. Each polarization converting segment 431 may include a converting region (or portion) 435 and a non-converting region (or portion) 433. In some embodiments, the non-converting region 433 may be disposed surrounding the converting region 435. In some embodiments, a size (or dimension) of the non-converting region 433 may be equal to or greater than a size (or dimension) S of the converting region 435. The converting region 435 may be configured to convert a polarization of a polarized light incident thereon to an orthogonal polarization, while transmitting the polarized light. The non-converting region 433 may be configured to substantially maintain a polarization of a polarized light incident thereon, while transmitting the polarized light.

For a polarized light including a first portion that is incident onto the converting region 435 and a second portion that is incident onto the corresponding non-converting region 433, the polarization converting segment 431 may be configured to output two lights having orthogonal polarizations. In some embodiments, the polarization converter 430 may include a patterned half-wave plate (“HWP”), in which the converting regions 435 may be configured to provide a half-wave birefringence (or half-wave phase retardance), and the non-converting region 433 may be configured to provide a zero or full wave birefringence (or zero or full wave phase retardance). Thus, the converting regions 435 may convert a polarization of a polarized light incident thereon into an orthogonal polarization while transmitting the polarized light, and the non-converting regions 433 may substantially maintain a polarization of a polarized light incident thereon while transmitting the polarized light.

In some embodiments, the converting regions 435 may be configured to provide a half-wave birefringence (or half-wave phase retardance) across a wide spectral (or wavelength) range (e.g., visible spectrum) and/or a wide incidence angle range. In other words, the polarization converter (e.g., patterned HWP) 430 may be broadband. In some embodiments, for an achromatic and/or wide angular design, the converting regions 435 may include a multi-layer birefringent material (e.g., a polymer, or an LC material) configured to provide a half-wave birefringence (or half-wave phase retardance) across a wide spectral range and/or a wide incidence angle range. In some embodiments, the converting regions 435 of the polarization converting segments 431, which are aligned with subpixels emitting image lights having a predetermined wavelength range, may be configured to provide a half-wave birefringence (or half-wave phase retardance) for the predetermined wavelength range. In other words, the converting regions 435 of the polarization converting segments 431, which are substantially aligned with subpixels emitting image lights having different wavelength ranges, may be configured to provide a half-wave birefringence (or half-wave phase retardance) for different wavelength ranges. For example, the converting regions 435 of the polarization converting segments 431, which are aligned with subpixels emitting red, blue, or green lights, may be configured to provide a half-wave birefringence (or half-wave phase retardance) for a red, blue, or green wavelength range.

In some embodiments, the converting regions 435 may include an optically anisotropic (or birefringent) material (e.g., an LC material), and the non-converting regions 433 may include an optically isotropic material (e.g., a glass, a polymer, etc.) In some embodiments, both of the converting regions 435 and the non-converting regions 433 may include an optically anisotropic (or birefringent) material (e.g., an LC material). The optically anisotropic molecules (e.g., LC molecules) may be configured with different alignments in the converting regions 435 and the non-converting region 433. For example, the optically anisotropic may be configured with an anti-parallel alignment in the converting regions 435, and have a vertical alignment in the non-converting region 433.

In some embodiments, at least one of the first waveplate 440 or the second waveplate 460 may function as a QWP. In some embodiments, at least one of the first waveplate 440 or the second waveplate 460 may function as a broadband QWP configured to provide a quarter-wave birefringence (or quarter-wave phase retardance) across a wide spectral (or wavelength) range (e.g., visible spectrum) and/or a wide incidence angle range. In some embodiments, for an achromatic and/or wide angular design, at least one of the first waveplate 440 or the second waveplate 460 may include a multi-layer birefringent material (e.g., a polymer, or an LC material) configured to provide a half-wave birefringence (or half-wave phase retardance) across a wide spectral range (e.g., visible spectrum) and/or a wide incidence angle range. In some embodiments, the polarizer 450 may be disposed between the first waveplate 440 and the second waveplate 460, and may be a linear absorption polarizer. In some embodiments, the combination of the first waveplate (e.g., QWP) 440, the polarizer (e.g., linear absorption polarizer) 450, and the second waveplate (e.g., QWP) 460 may function as a circular polarizer 470 (e.g., an absorption type), e.g., across a wide spectral range and/or a wide incidence angle range.

In the embodiment shown in FIG. 4A, the first waveplate 440, the polarizer 450, and the second waveplate 460 are shown as spaced apart from one another by a gap. In some embodiments, the first waveplate 440, the polarizer 450, and the second waveplate 460 may be stacked without a gap. In the embodiment shown in FIG. 4A, the first waveplate 440 is shown as spaced apart from the polarization converter 430 by a gap. In some embodiments, the first waveplate 440 and the polarization converter 430 may be stacked without a gap.

FIGS. 4A-4C show an optical path of an image light 471 in the display device 400, according to an embodiment of the present disclosure. For discussion purposes, FIGS. 4A-4C show the optical path of the image light 471 in a portion of the display device 400 corresponding to a single light-emitting element 411. Optical paths of the image light 471 in the entire display device 400 may be substantially the same as that shown in FIGS. 4A-4C. In FIGS. 4A-4C, “R” denotes an RHCP light, “L” denotes an LHCP light, “s” denotes an s-polarized light, and “p” denotes a p-polarized light. An s-polarized light and a p-polarized light are linearly polarized lights with orthogonal polarizations. An RHCP light and an LHCP light are circularly polarized lights with orthogonal polarizations.

In some embodiments, as shown in FIG. 4A, the light-emitting elements 411 of the display panel 410 may be configured to emit lights (e.g., image lights) in both forward and backward directions. The image lights may be linearly polarized lights or unpolarized lights. For example, the light-emitting elements 411 may emit the image light 471 in a forward direction toward the microlens array 420 (e.g., T-PVH microlens array), and emit an image light 472 in a backward direction. For discussion purposes, the image light 471 and the image light 472 may be unpolarized lights including an RHCP component and an LHCP component. The image light 471 may be incident onto both a central portion and a periphery portion of the microlens 421. The central portion and the periphery portion of the microlens 421, which are similar to those shown in FIG. 5A, are not labelled in FIG. 4A.

The microlens array 420 may be configured to transform (e.g., via forward diffraction) a first portion of the image light 471 to a first polarized light (e.g., an RHCP light) 473, and transform (e.g., via forward diffraction and/or transmission with negligible diffraction) a second portion of the image light 471 to a second polarized light (e.g., an LHCP light) 474. The first portion and the second portion of the image light 471 may be defined in a manner similar to the first portion and the second portion of the light 552 (shown in FIG. 5C), as described above. In some embodiments, the first polarized light (e.g., RHCP light) 473 may be a focused or convergent light that is focused to a point “O” on an optical axis of the microlens 421. The point “O” may be within a plane 465 that is perpendicular to the optical axis of the microlens 421. The plane 465 may be referred to as an image plane of the microlens array 420.

In some embodiments, the image light 471 output from the display panel 410 may be a substantially collimated light, e.g., a fully collimated light or a non-fully collimated light with a negligible divergence. Thus, the point O may be at or in proximity to a positive focal point of the microlens 421, and the image plane 465 may be at or in proximity to a positive focal plane of the microlens array 420. The second polarized light (e.g., LHCP light) 474 may be a defocused or divergent light. In some embodiments, the first polarized light (e.g., RHCP light) 473 and the second polarized light (e.g., LHCP light) 474 may be orthogonally circularly polarized lights.

In some embodiments, the microlens array 420 may be configured with a high diffraction efficiency at both of the central portion and the peripherical portion of the microlenses 421, e.g., an efficiency greater than 95%. Thus, a combination of the first polarized light (e.g., RHCP light) 473 and the second polarized light (e.g., LHCP light) 474 output from the microlens array 420 may have an energy that is substantially the same as the energy of the image light 471. In some embodiments, the energy of the first polarized light 473 may be smaller than the energy of the second polarized light 474.

The first polarized light 473 and the second polarized light 474 may propagate toward the polarization converter 430. In some embodiment, the polarization converter 430 may be spaced apart from the microlens array 420 by a distance d. In some embodiments, at a plane intersecting the polarization converting segment 431, a beam size of the second polarized light 474 may be configured to be the same as or smaller than a size of the polarization converting segment 431, and greater than a size of the converting region 435 of the polarization converting segment 431. In other words, the second polarized light 474 may be incident onto both of the converting region 435 and the non-converting region 433 of the polarization converting segment 431. In some embodiments, at a plane intersecting the polarization converting segment 431, a beam size of the first polarized light 473 may be configured to be the same as or smaller than a size of the converting region 435 of the polarization converting segment 431. In other words, the first polarized light 473 may be incident onto the converting region 435 of the polarization converting segment 431, and may not be incident onto the non-converting region 433 of the polarization converting segment 431. At the plane intersecting the polarization converting segment 431, the beam size of the first polarized light 473 may be configured to be smaller than the beam size of the second polarized light 474.

In other words, the microlens array 420 (e.g., T-PVH microlens array) may be configured to transform the first portion of the image light 471 as the first polarized light 473 that is incident onto the converting region 435 of the polarization converting segment 431. The microlens array 420 may transform the second portion of the image light 471 as the second polarized light 474 that is incident onto both of the converting region 435 and the non-converting region 433 of the polarization converting segment 431.

For example, the polarization converting segment 431 may be configured with a first circular shape having a first radius, and the converting region 435 may be configured with a second circular shape having a second radius that is smaller than the first radius. The beam spot of the second polarized light 474 at a plane intersecting both of the converting region 435 and the non-converting region 433 may be configured with a third circular shape having a third radius. The beam spot of the first polarized light 473 at a plane intersecting the converting region 435 may be configured with a fourth circular shape having a fourth radius. The third radius may be the same as or smaller than the first radius, and greater than the second radius. The fourth radius may be smaller than the third radius. The fourth radius may be the same as or smaller than the second radius.

FIG. 4B illustrates an optical path of the first polarized light (e.g., RHCP light) 473 output from the microlens array 420. As shown in FIGS. 4A and 4B, the substantially entire first polarized light 473 may be incident onto the converting region 435 of the polarization converting segment 431, and no portion (or only a negligible portion) of the first polarized light 473 is incident onto the non-converting region 433 of the polarization converting segment 431. The converting region 435 may be configured to convert the polarization of the first polarized light 473 into an orthogonal polarization while transmitting the first polarized light 473. The converting region 435 may output a circularly polarized light (e.g., an LHCP) light 475 propagating toward the circular polarizer 470. The circular polarizer 470 may be configured to substantially transmit an LHCP light and substantially block an RHCP light via absorption. Thus, the circular polarizer 470 may substantially transmit the circularly polarized light 475 as a circularly polarized light (e.g., an LHCP light) 481. The circularly polarized light 481 may propagate toward a viewer of the display device 400.

For example, as shown in FIGS. 4A and 4B, the first waveplate 440 may be configured to convert the circularly polarized light 475 into a linearly polarized light (e.g., an s-polarized light) 477 propagating toward the polarizer 450. The polarizer 450 may be configured to substantially transmit an s-polarized light and substantially block a p-polarized light. Thus, the polarizer 450 may be configured to substantially transmit the s-polarized light 477 as an s-polarized light 479 propagating toward the second waveplate 460. The second waveplate 460 may be configured to convert the s-polarized light 479 into the circularly polarized light (e.g., LHCP light) 481.

Thus, the circularly polarized light 475 output from the converting region 435 of the polarization converter 430 may be output from the display device 400 as the circularly polarized light 481 that may be perceived by the viewer. In other words, substantially the entire first polarized light (e.g., RHCP light) 473 output from the microlens array 420 may be delivered to the viewer. In some embodiments, the first portion of the image light 471 that is transformed to the first polarized light 473 by the microlens array 420 may be substantially entirely delivered to the viewer. For discussion purposes, the circularly polarized light 481 output from the display device 400 is presumed to have an energy that is substantially the same as the first portion of the image light 471.

FIG. 4C illustrates an optical path of the second polarized light (e.g., LHCP light) 474 output from the microlens array 420 (e.g., T-PVH microlens array). Referring to FIG. 4A and FIG. 4C, the second polarized light 474 output from the microlens array 420 may be incident onto both of the converting region 435 and the corresponding non-converting region 433 of the polarization converting segment 431. For example, the second polarized light 474 may include a central portion that is incident onto the converting region 435, and a periphery portion that is incident onto the corresponding non-converting region 433 surrounding the converting region 435. The converting region 435 may be configured to convert the polarization of the central portion of the second polarized light 474 into an orthogonal polarization, while transmitting the central portion of the second polarized light 474. For example, the converting region 435 may be configured to output a circularly polarized light (e.g., an RHCP) light 478 toward the circular polarizer 470. The non-converting region 433 may be configured to substantially maintain the polarization of the periphery portion of the second polarized light 474, and may output a circularly polarized light (e.g., an LHCP light) 476 toward the circular polarizer 470. As the circular polarizer 470 is configured to substantially transmit an LHCP light and substantially block an RHCP light via absorption, the circular polarizer 470 may substantially transmit the circularly polarized light 476 as a circularly polarized light (e.g., an LHCP light) 486 propagating toward the viewer of the display device 400, and substantially block the circularly polarized light (e.g., RHCP light) 478.

For example, as shown in FIGS. 4A and 4C, the first waveplate 440 may be configured to convert the circularly polarized light 476 and the circularly polarized light 478 into a linearly polarized light (e.g., an s-polarized light) 480 and a linearly polarized light (e.g., a p-polarized light) 482, respectively. As the polarizer (450 may be configured to substantially transmit an s-polarized light and substantially block a p-polarized light, the polarizer 450 may substantially transmit the s-polarized light 480 as an s-polarized light 484 propagating toward the second waveplate 460, and substantially block the p-polarized light 482 via absorption. The second waveplate 460 may be configured to convert the s-polarized light 484 into the circularly polarized light (e.g., LHCP light) 486, while transmitting the s-polarized light 484.

Thus, the circularly polarized light (e.g., LHCP light) 476 output from the non-converting region 433 of the polarization converter 430 may be delivered to the viewer. The central portion of the second polarized light (e.g., LHCP light) 474 output from the microlens array 420 may not be output by the display device 400, while the periphery portion of the second polarized light 474 may be output by the display device 400, and delivered to the viewer, as shown in FIGS. 4A and 4C. As the second polarized light 474 is transformed from the second portion of the image light 471 by the microlens array 420, the central portion of the second portion of the image light 471 emitted from the display panel 410 may not be output by the display device 400, while the periphery portion of the second portion of the image light 471 may be output by the display device 400 and delivered to the viewer.

The display device 400 may be configured to output the first portion of the image light 471 as the circularly polarized light (e.g., LHCP light) 481, the first portion being the LHCP component of the central portion of the image light 471. The display device 400 may be configured to output the periphery portion of the second portion of the image light 471 as the circularly polarized light (e.g., LHCP light) 486, the second portion being a combination of the RHCP component of the central portion of the image light 471 and the periphery portion of the image light 471 including both the LHCP component and the RHCP component. Thus, for the image light 471 emitted from the display panel 410, an overall output light 488 of the display device 400 may include the circularly polarized light (e.g., LHCP light) 481 and the circularly polarized light (e.g., LHCP light) 486.

In the embodiment shown in FIGS. 4A-4C, the microlens array 420 may be configured to defocus (or diverge) the second portion of the image light 471 as the second polarized light (e.g., LHCP light) 474, with a substantially small divergence, which may be desirable for high resolution displays. For example, the parameters of the microlens array 420 may be configured, such that the microlens array 420 may transform (e.g., via forward diffraction and/or transmission with negligible diffraction) the second portion of the image light 471 to the second polarized light (e.g., LHCP light) 474 in a substantially small diffraction angle.

In conventional technology, for an unpolarized light, only one component of a predetermined handedness may be output by a display device. For example, only the right-handed component of the unpolarized light may be output by the display device. The other component (e.g., the left-handed component) may not be output by the display device. Thus, for a conventional display, the transmittance or efficiency may be no more than 50%. With the disclosed system, not only the component of the predetermined handedness of an input image light is output by the display device, the periphery portion of the other component of the opposite handedness is also output from the disclosed display device. Thus, the disclosed display device can provide a transmittance or efficiency greater than 50%.

For discussion purpose, the circularly polarized light (e.g., LHCP light) 481 output by the display device 400 is presumed to have an energy that is substantially the same as the energy of the first portion of the image light 471. The circularly polarized light (e.g., LHCP light) 486 output by the display device 400 is presumed to have an energy that is substantially the same as the energy of the periphery portion of the second portion of the image light 471. In some embodiments, the overall output light 488 may have an energy that is greater than half (or 50%) of the energy of the image light 471. For example, the overall output light 488 may have an energy that is about 95%, 90%, 85%, 80%, 75%, 70%, 65%, 60%, or 55% of the energy of the image light 471.

Referring to FIG. 4A, for the image light 472 emitted from the light-emitting elements 411 in the backward direction, a reflective electrode (not shown) may be disposed at the bottom of the light-emitting elements 411 (referred to as a bottom reflective electrode). The reflective electrode may be configured to reflect the image light 472 back to the microlens array 420. Thus, the image light 472 may also be output by the display device 400. Hence, the power efficiency of the display device 400 may be increased. The reflected light (not shown) from the reflective electrode may have an optical path that is similar to that of the image light 471 when the reflected light propagates through the microlens array 420, the polarization converter 430, and the circular polarizer 470. Similarly, an overall output light of the display device 400 corresponding to the image light 472 may have an energy that is greater than half (or 50%) of the energy of the image light 472, such as about 95%, 90%, 85%, 80%, 75%, 70%, 65%, 60%, or 55% of the energy of the image light 472. Thus, for an overall image light (including the image light 471 and the image light 472) emitted from the display panel 410, an overall output light of the display device 400 may have an energy that is greater than half (or 50%) of the energy of the overall image light, such as about 95%, 90%, 85%, 80%, 75%, 70%, 65%, 60%, or 55% of the energy of the overall image light. In other words, the overall light transmittance of the display device 400 may be greater than 50%, such as 95%, 90%, 85%, 80%, 75%, 70%, 65%, 60%, or 55%.

Referring to FIGS. 4A-4C, the overall light transmittance of the display device 400 may be determined, in part, by the size S of the converting region 435 included in the polarization converter 430, and the distance d between the polarization converter 430 and the microlens array 420. In some embodiments, the beam size of the first polarized light (e.g., focused RHCP light) 473 at a plane intersecting the polarization converting segment 431 may be configured to be substantially the same as (e.g., equal to or slightly smaller than) the size (or dimension) S of the converting region 435. The beam size of the second polarized light (e.g., defocused LHCP light) 474 at a plane intersecting the polarization converting segment 431 may be configured to be larger than the size S of the converting region 435, and the same as or smaller than the size of the polarization converting segment 431. As the distance d increases (e.g. when the polarization converter 430 moves away from the microlens array 420), the converting region 435 having a reduced size S may be used. The energy of the circularly polarized light (e.g., LHCP light) 481 output from the display device 400 may be substantially unchanged as the distance d varies, while the energy of the circularly polarized light (e.g., LHCP light) 486 output from the display device 400 may increase, as the central portion of the defocused light 474 that is absorbed by the polarizer 450 is reduced. Thus, the energy of the overall output light 488 of the display device 400 may increase.

In some embodiments, the polarization converter 430 may be disposed substantially at (e.g., within a predetermined range of distance from) the image plane 465 of the microlens array 420. In such embodiments, the converting region 435 having a predetermined minimum size may be used. Thus, the energy of the overall output light 488 of the display device 400 may have a predetermined maximum value. In such an embodiment, the converting region 435 and the beam spot of the focused light 473 at a plane intersecting the polarization converter 430 may be aligned with one another at a high accuracy. An alignment offset between the converting region 435 and the beam spot of the first polarized light (e.g., RHCP light) 473 may cause a significant decrease in the energy of the overall output light 488 of the display device 400. In some embodiments, the polarization converter 430 may be disposed adjacent the image plane 465 of the microlens array 420, for example, within a predetermined distance range of the image plane 465. For example, when the distance between the image plane 465 and the microlens array 420 is D, the distance d between the polarization converter 430 and the microlens array 420 may be configured to be within a predetermined percentage of the distance D. For example, the predetermined percentage may be about 80%, 85%, 90%, 95%, 100%, 105%, 110%, 115%, 120%. In some embodiments, the image plane 465 of the microlens array 420 may be the positive focal plane of the microlens array 420, and the distance D between the image plane 465 and microlens array 420 may be a focal length of the microlens array 420.

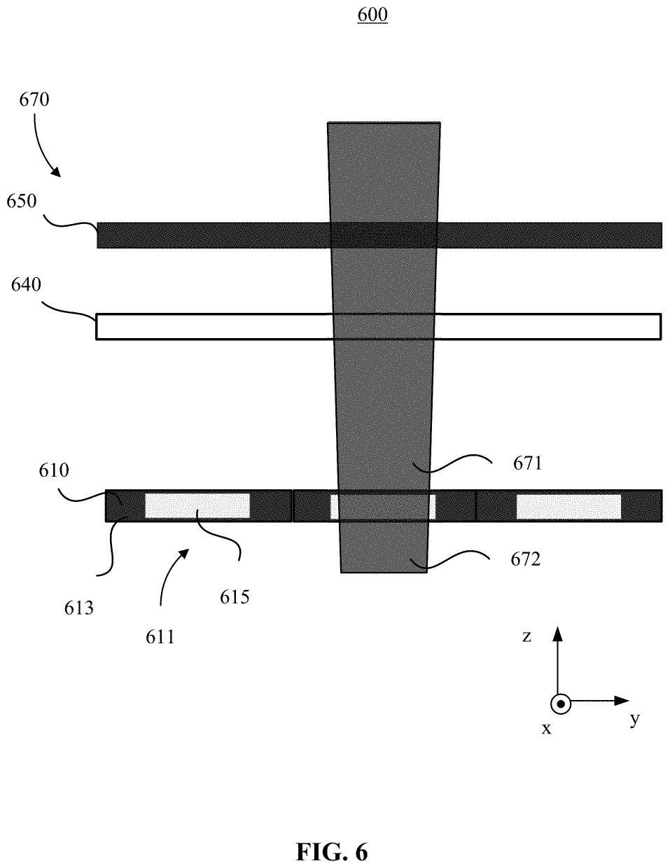

FIG. 6 schematically illustrates an optical path of an image light in a conventional emissive display device 600. As shown in FIG. 6, the conventional emissive display device 600 may include a display panel 610, and a circular polarizer 670 laminated over the display panel 610. The circular polarizer 670 may include a waveplate 640 and a linear polarizer 650. The display panel 610 may include a plurality of light-emitting elements 611. Each light-emitting element 611 may include a light-emitting area 615 and a non-emitting area 613 surrounding the light-emitting area 615. The circular polarizer 670 may be configured to block the reflected ambient light from the bottom reflective electrode (not shown) of the light-emitting elements 611 in the display panel 610. The conventional emissive display device 600 may not include the microlens assembly 420 and the polarization converter 430 shown in FIGS. 4A-4C. At least half of the energy of an image light 671 (and an image light 672) emitted from the display panel 610 (in the forward direction and the backward direction) may be absorbed by the circular polarizer 670. Thus, an overall light transmittance of the conventional emissive display device 600 may be less than 50%. In other words, the power efficiency of the conventional emissive display device 600 may be less than 50%.

Compared to the conventional emissive display device 600 shown in FIG. 6, the disclosed display device 400 shown in FIGS. 4A-4C may include the microlens array 420 (e.g., T-PVH microlens array) and the polarization converter 430 (which may be a patterned polarization converter) disposed between the display panel 410 and the circular polarizer 470. A combination of the microlens array 420 and the polarization converter 430 may be referred to as a polarization converting device. For the image light 471 incident onto the microlens array 420, the microlens array 420 may be configured to output the focused light 473 and the defocused light 474 with a high diffraction efficiency (e.g., larger than 95%) from the center to the peripheries of the microlens 421. In addition, the display device 400 disclosed herein may be configured to provide an overall light transmittance that is greater than 50%. For example, through configuring the size S of the converting region 435 included in the polarization converter 430, and the distance d between the polarization converter 430 and the microlens array 420, the overall light transmittance of the display device 400 disclosed herein may be 95%, 90%, 85%, 80%, 75%, 70%, 65%, 60%, or 55%. Thus, with the microlens array 420 and the polarization converter 430 that are disposed “in-cell” between the display panel 410 and the circular polarizer 470, the power efficiency of the display device 400 may be significantly increased as compared to a conventional emissive display device. The microlens array 420 may enlarge an emission cone of the light-emitting elements 411 of the display panel 410, thereby expanding an eye-box of the display device 400.

FIG. 4D schematically illustrates a y-z sectional view of a display device 455, according to an embodiment of the present disclosure. The display device 455 may include elements, structures, and/or functions that are the same as or similar to those included in the display device 400 shown in FIGS. 4A-4C. Descriptions of the same or similar elements, structures, and/or functions can refer to the above descriptions rendered in connection with FIGS. 4A-4C. As shown in FIG. 4D, the display device 455 may include the display panel 410, the microlens array 420, the polarization converter 430 (which may be a patterned polarization converter), the polarizer 450, and the second waveplate 460 arranged in an optical series. For illustrative purposes, in FIG. 4D, the display panel 410, the microlens array 420, the polarization converter 430, the polarizer 450, and the second waveplate 460 are shown as having flat surfaces. In some embodiments, one or more of the display panel 410, the microlens array 420, the polarization converter 430, the polarizer 450, and the second waveplate 460 may have curved surfaces.

In the embodiment shown in FIG. 4D, the microlens array 420 may be linear polarization selective. For example, the microlens array 420 may be a liquid crystal microlens array configured to focus a first linearly polarized light with a predetermined polarization direction, and transmit a second linearly polarized light with a polarization direction that is orthogonal to the predetermined polarization direction. In other words, the microlens array 420 may be configured to change a propagation direction and a wavefront of the first linearly polarized light while transmitting the first linearly polarized light, and substantially maintain a propagation direction and a wavefront of the second linearly polarized light, while transmitting the second linearly polarized light. For an input light including two orthogonally linearly polarized components (e.g., an s-polarized component and a p-polarized component), the microlens array 420 may be configured to focus one of the two orthogonally linearly polarized components and output a focused light, and transmit the other one of the two orthogonally linearly polarized components and output an unfocused light. The microlens array 420 may substantially maintain the polarization of the two orthogonally linearly polarized components, while transmitting the two orthogonally linearly polarized components.

FIG. 4D illustrates an optical path of the image light 471 in the display device 455 according to an embodiment of the present discourse. For discussion purposes, FIG. 4D shows the optical path of the image light 471 in a portion of the display device 455 corresponding to a single light-emitting element 411. Optical paths of the image light in the other portions of the display device 455 corresponding to other light emitting elements may be substantially the same as that shown in FIG. 4D. In FIG. 4D, “L” denotes an LHCP light, “s” denotes an s-polarized light, and “p” denotes a p-polarized light. An s-polarized light and a p-polarized light are orthogonally linearly polarized lights. For discussion purposes, the image light 471 may be an unpolarized light and may be substantially collimated.

As shown in FIG. 4D, the microlens array 420 may be configured to transform a first portion of the image light 471 as a first polarized light 491, and transform a second portion of the image light 471 as a second polarized light 490. In as the embodiment shown in FIG. 4D, the first portion of the image light 471 may be a p-polarized component of the image light 471, and the second portion of the image light 471 may be an s-polarized component of the image light 471. In some embodiments, the first polarized light 491 may be a focused (or convergent) light, and the second polarized light 491 may be an unfocused (or substantially collimated) light. In some embodiments, the microlens array 420 may be configured to focus (or converge) the first portion of the image light 471 (e.g., p-polarized component of the image light 471) as the first polarized light (e.g., focused (or convergent)) light 491. The microlens array 420 may substantially transmit, without negligible converging or diverging effect, the second portion of the image light 471 (e.g., s-polarized component of the light 471) as the second polarized light (e.g., unfocused light 490).

In some embodiments, the first polarized light (e.g. focused light) 491 output from the microlens array 420 may be a linearly polarized light (e.g., a p-polarized light), which may be referred to as a p-polarized light 491 for discussion purposes. The second polarized light (e.g., unfocused light) 490 output from the microlens array 420 may be a linearly polarized light (e.g., an s-polarized light), which may be referred to as an s-polarized light 490 for discussion purposes. In some embodiments, the energies of the p-polarized light 491 and the s-polarized light 490 output from the microlens array 420 may be substantially the same, e.g., about 50% of the energy of the light 471 output from the display panel 410.

In some embodiments, substantially the entire linearly polarized light (e.g., p-polarized light) 491 output from the microlens array 420 may be incident onto the converting region 435 of the polarization converting segment 431, and may not be incident onto the non-converting region 433 of the polarization converting segment 431. The converting region 435 may be configured to convert the polarization of the p-polarized light 491 into an orthogonal polarization (i.e., s-polarization) while transmitting the p-polarized light 491. The converting region 435 may output an s-polarized light 493 toward the polarizer (e.g., linear absorption polarizer) 450. The polarizer 450 may be configured to substantially transmit an s-polarized light and substantially block (e.g., via absorption) a p-polarized light. Thus, the polarizer 450 may substantially transmit the s-polarized light 493 as an s-polarized light 495 propagating toward the second waveplate 460. The second waveplate 460 may be configured to convert the s-polarized light 495 into a circularly polarized light (e.g., LHCP light) 497 propagating toward a viewer of the display device 455, while transmitting the s-polarized light 495. In some embodiments, the combination of the linear absorption polarizer 450 and the second waveplate 460 may also be referred to as a circular polarizer (e.g., circular absorption polarizer) 489.

Thus, the linearly polarized light (e.g., s-polarized light) 493 output from the converting region 435 of the polarization converter 430 may be delivered to the viewer. In other words, the p-polarized light 491 output from the microlens array 420 may be output by the display device 455, and may be perceived by the viewer. In other words, the first portion (e.g., the p-polarized component) of the image light 471 emitted from the display panel 410 may be output by the display device 455, and may be perceived by the viewer. In some embodiments, the first portion (e.g., the p-polarized component) of the image light 471 may include half (or 50%) of the energy of the image light 471. For discussion purposes, the circularly polarized light (e.g., LHCP light) 497 output from the display device 455 is presumed to have an energy that is substantially the same as the energy of the first portion (e.g., the p-polarized component) of the image light 471. Thus, the circularly polarized light (e.g., LHCP light) 497 may include half (or 50%) of the energy of the image light 471.

The linearly polarized light (e.g., s-polarized light) 490 output from the microlens array 420 may be incident on both of the converting region 435 and the non-converting region 433 of the polarization converting segment 431. The s-polarized light 490 may include a central portion that is incident onto the converting region 435, and a periphery portion that is incident onto the non-converting region 433. The converting region 435 may be configured to convert the polarization of the central portion of the s-polarized light 490 into an orthogonal polarization (i.e., the p-polarization) while transmitting the central portion of the s-polarized light 490. Thus, the converting region 435 may output a linearly polarized light (e.g., a p-polarized light) 494 toward the polarizer 450. The non-converting region 433 may be configured to substantially maintain the polarization of the periphery portion of the s-polarized light 490, and output a linearly polarized light (e.g., an s-polarized light) 492 propagating toward the polarizer 450.

As the polarizer 450 may be configured to substantially transmit an s-polarized light and substantially block a p-polarized light, the polarizer 450 may transmit the s-polarized light 492 as an s-polarized light 496 propagating toward the second waveplate 460, and may substantially block the p-polarized light 494 via absorption. The second waveplate 460 may be configured to convert the s-polarized light 496 into an LHCP light 498, while transmitting the s-polarized light 496.

Thus, the s-polarized light 492 output from the non-converting region 433 of the polarization converting segment 431 may be output by the display device 455 as the LHCP light 498, which may be perceived by a viewer. In other words, the periphery portion of the s-polarized light 490 output from the microlens array 420 may be output by the display device 455 as the LHCP light 498, which may be perceived by the viewer. In other words, a central portion of the second portion (e.g., the s-polarized component) of the image light 471 emitted from the display panel 410 may not be output by the display device 455, while a periphery portion of the second portion (e.g., s-polarized component) of the image light 471 may be output from by display device 455 as the LHCP light 498, which may be perceived by the viewer.

In some embodiments, the periphery portion of the second portion (e.g., s-polarized component) of the image light 471 may have an energy that is less than half (or 50%) of the energy of the image light 471 and greater than zero. For discussion purposes, the LHCP light 498 output from the display device 455 is presumed to have an energy that is substantially the same as the energy of the periphery portion of the second portion of the image light 471. Thus, the LHCP light 498 output from the display device 455 may have an energy that is less than half (or 50%) of the energy of the image light 471 and greater than zero. For example, the LHCP light 498 output from the display device 455 may have an energy that is about 45%, 40%, 35%, 30%, 25%, 20%, 15%, 10%, or 5% of the energy of the image light 471.

The display device 455 may be configured to output the first portion (e.g., p-polarized component) of the image light 471 as the LHCP light 497, and output the periphery portion of the second portion (e.g., s-polarized component) of the image light 471 as the LHCP light 498. The LHCP light 497 may have an energy that is substantially half (or 50%) of the energy of the image light 471. The LHCP light 498 may have an energy that is less than half (or 50%) of the energy of the image light 471 and greater than zero. Thus, for the image light 471 emitted from the display panel 410, an overall output light 499 of the display device 455 may include the LHCP light 497 and the LHCP light 498. The overall output light 499 may have an energy that is greater than half (or 50%) of the energy of the image light 471. For example, when the LHCP light 498 has an energy that is about 45%, 40%, 35%, 30%, 25%, 20%, 15%, 10%, or 5% of the energy of the image light 471, the overall output light 499 may have an energy that is about 95%, 90%, 85%, 80%, 75%, 70%, 65%, 60%, or 55% of the energy of the image light 471.

In the embodiment shown in FIG. 4D, the image light 472 emitted from the light-emitting elements 411 in the backward direction may be reflected by the reflective electrode disposed at the bottom of the display panel 410 back to the microlens array 420. The reflected light (not shown) may have an optical path that is similar to that of the image light 471 when propagating through the microlens array 420, the polarization converter 430, the polarizer 450, and the second waveplate 460.

Similar to the display device 400 shown in FIGS. 4A-4C, in the embodiment shown in FIG. 4D, the overall light transmittance of the display device 455 may be determined, in part, by the size S of the converting region 435 included in the polarization converter 430, and the distance d between the polarization converter 430 and the microlens array 420. In some embodiments, the beam size of the focused light 491 at a plane intersecting the polarization converting segment 431 may be configured to be the same as or slightly smaller than the size (or dimension) S of the converting region 435. The beam size of the unfocused light 490 at a plane intersecting the polarization converting segment 431 may be configured to be larger than the size (or dimension) S of the converting region 435, and the same as or smaller than the size (or dimension) of the polarization converting segment 431. As the distance d increases (e.g., when the polarization converter 430 moves away from the microlens array 420), a reduced size S may be used for the converting region 435. The energy of the circularly polarized light (e.g., LHCP light) 497 output from the display device 455 may be substantially unchanged as the distance d varies. The energy of the circularly polarized light (e.g., LHCP light) 498 output from the display device 455 may increase, as the central portion of the unfocused light 490 that is absorbed by the polarizer 450 is reduced. Thus, the energy of the overall output light 499 of the display device 455 may increase.

Compared to the conventional emissive display device 600 shown in FIG. 6, in the disclosed display device 455 shown in FIG. 4D, the cross-talk between neighboring subpixels 411 may be significantly reduced, and the display resolution may be increased. In addition, the disclosed display device 455 may be configured to provide an overall light transmittance that is greater than 50%. For example, through configuring the size of the converting region 435 included in the polarization converter 430, and the distance d between the polarization converter 430 and the microlens array 420, the overall light transmittance of the disclosed display device 455 may be configured to be 95%, 90%, 85%, 80%, 75%, 70%, 65%, 60%, or 55%. Thus, with the microlens array 420 and the polarization converter 430 that are disposed “in-cell”, the disclosed display device 455 may provide a significantly increased power efficiency as compared to the conventional emissive display device 600 shown in FIG. 6.

In the display device 400 or 455 shown in FIGS. 4A-4D, the microlens array 420 is shown to be a spherical microlens array, which is for illustrative purposes. In some embodiments, the microlens array 420 may be a spherical microlens array, an aspherical microlens array, a cylindrical microlens array, or a freeform microlens array, etc. The microlens 421 may be a spherical microlens, an aspherical microlens, a cylindrical microlens, or a freeform microlens, etc. The microlens array 420 may be fabricated using any suitable fabrication method, such as holographic interference, laser direct writing, ink-jet printing, or various other forms of lithography. For example, in some embodiments, a photo-alignment material may be disposed at the display panel 410 and optically patterned (e.g., via a polarization interference) to form an alignment layer corresponding to a desirable microlens array. A polymerizable LC material may be disposed on the alignment layer, and aligned by the alignment layer to form the desirable microlens array. The LC material may be further polymerized to stabilize the microlens array. In some embodiments, a birefringent photo-refractive holographic material other than the LC material may be disposed at the display panel 410 and optically patterned (e.g., via a polarization interference) to form a desirable microlens array directly. The above-mentioned steps may be repeated to fabricate a plurality of microlens arrays on the display panel 410. The microlens array may be fabricated “in-cell” with an alignment offset (or alignment displacement) of less than or equal to 2 μm (or 1 μm, or 100 nm) with respect to the array of the light-emitting elements (or subpixels) 411. In some embodiments, two-photon polarization laser writing may be used to fabricate a freeform microlens array.

The disclosed display systems with improved resolution, light transmittance and power efficiency may have numerous applications in a large variety of fields, e.g., near-eye displays (“NEDs”), head-up displays (“HUDs”), head-mounted displays (“HMDs”), smart phones, laptops, televisions, monitors, projectors, vehicles, etc. For example, the display devices disclosed herein may be implemented into an optical system to boost the display brightness, improve the battery time, and reduce the ghost images and increase the contrast ratio in a bright environment. Some exemplary applications in augmented reality (“AR”), virtual reality (“VR”), mixed reality (“MR)” fields or some combinations thereof will be explained below. Near-eye displays (“NEDs”) have been widely used in a large variety of applications, such as aviation, engineering, science, medicine, computer gaming, video, sports, training, and simulations. One application of NEDs is to realize VR, AR, MR or some combination thereof.

Desirable characteristics of NEDs include compactness, light weight, high resolution, large field of view (“FOV”), and small form factor. An NED may include a display element configured to generate an image light and a lens system configured to direct the image light toward eyes of a user. The lens system may include a plurality of optical elements, such as lenses, waveplates, reflectors, etc., for focusing the image light to the eyes of the user. To achieve a compact size and light weight and to maintain satisfactory optical characteristics, an NED may adopt a pancake lens assembly in the lens system to fold the optical path, thereby reducing a back focal distance in the NED.

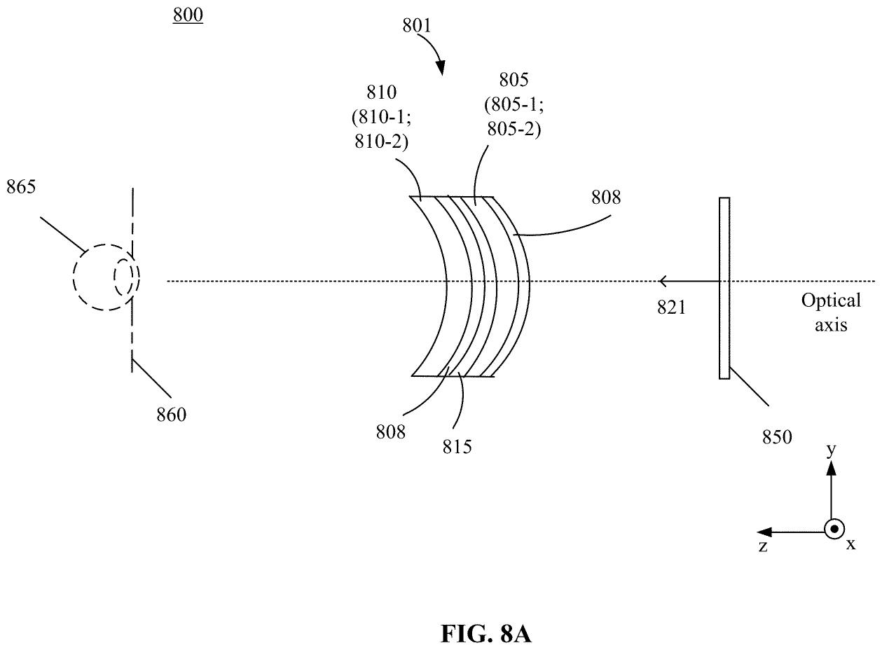

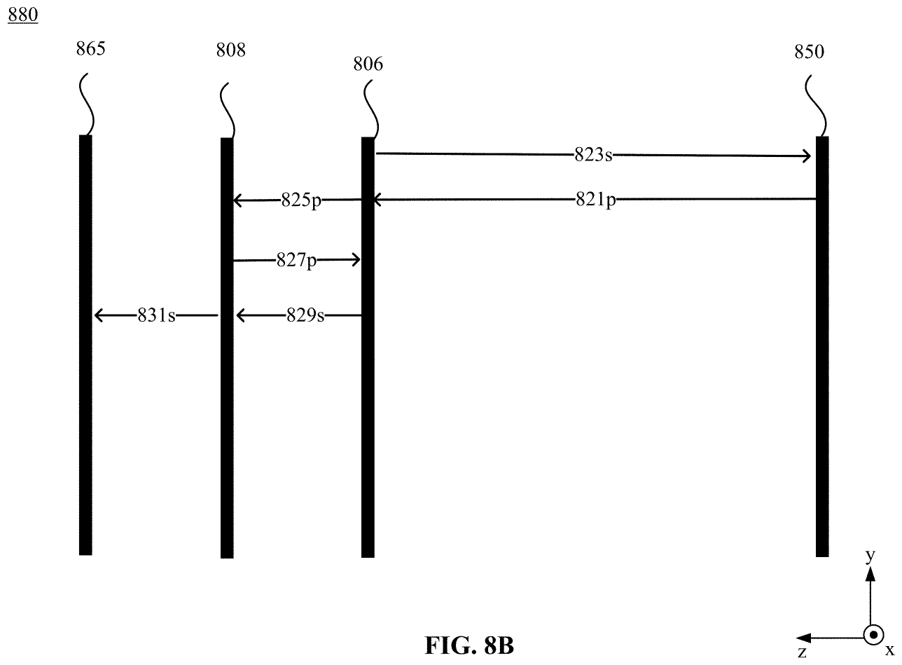

FIG. 8A illustrates a schematic diagram of an optical system 800 according to an embodiment of the present disclosure. The optical system 800 may include a display device 850, and a pancake lens assembly 801 coupled to the display device 850. The display device 850 may be configured to display a virtual image with high brightness and contrast ratio. In some embodiments, the display device 850 may be a monochromatic display device, e.g., a red, green, or blue display device. In some embodiments, the display device 850 may be a polychromatic display device, e.g., a red-green-blue (“RGB”) display device. In some embodiments, the display device 850 may be a polychromatic display device including a stack of a plurality of monochromatic displays, e.g., an RGB display device including a stack of red, green, and blue display devices. The display device 850 may be an embodiment of the display devices disclosed herein, such as the display device 100 shown in FIG. 1A, the display device 190 shown in FIG. 1G, the display device 400 shown in FIG. 4A, or the display device 455 shown in FIG. 4D.

As shown in FIG. 8A, the display device 850 may be configured to output a polarized image light 821 (that forms the virtual image) toward the pancake lens assembly 801. The pancake lens assembly 801 may be configured to focus the polarized image light 821 to an eye-box located at an exit pupil 860. The exit pupil 860 may be at a location where an eye 865 is positioned in an eye-box region when a user wears the NED. In some embodiments, the pancake lens assembly 801 may include a first optical element 805 and a second optical element 810. In some embodiments, the pancake lens assembly 801 may be configured as a monolithic pancake lens assembly without any air gaps between optical elements included in the pancake lens assembly. In some embodiments, one or more surfaces of the first optical element 805 and the second optical element 810 may be shaped (e.g., curved) to compensate for the field curvature. In some embodiments, one or more surfaces of the first optical element 805 and/or the second optical element 810 may be shaped to be spherically concave (e.g., a portion of a sphere), spherically convex, a rotationally symmetric asphere, a freeform shape, or some other shape that can mitigate the field curvature. In some embodiments, the shape of one or more surfaces of the first optical element 805 and/or the second optical element 810 may be designed to additionally compensate for other forms of optical aberration.

In some embodiments, one or more of the optical elements within the pancake lens assembly 801 may have one or more coatings, such as an anti-reflective coating, configured to reduce ghost images and enhance contrast. In some embodiments, the first optical element 805 and the second optical element 810 may be coupled together by an adhesive 815. Each of the first optical element 805 and the second optical element 810 may include one or more optical lenses. In some embodiments, at least one of the first optical element 805 or the second optical element 810 may have at least one flat surface.

The first optical element 805 may include a first surface 805-1 facing the display device 850 and an opposing second surface 805-2 facing the eye 865. The first optical element 805 may be configured to receive an image light from the display device 850 at the first surface 805-1 and output an image light with an altered property at the second surface 805-2. The pancake lens assembly 801 may also include a mirror 806 that may be an individual layer, film, or coating disposed at (e.g., bonded to or formed at) the first optical element 805. The mirror 806 may be disposed at (e.g., bonded to or formed at) the first surface 805-1 or the second surface 805-2 of the first optical element 805.

For discussion purposes, FIG. 8A shows that the mirror 806 is disposed at (e.g., bonded to or formed at) the first surface 805-1. In some embodiments, the mirror 806 may be disposed at the second surface 805-2 of the first optical element 805. In some embodiments, the mirror 806 may be a partial reflector that is partially reflective to reflect a portion of a received light. In some embodiments, the mirror 806 may be configured to transmit about 50% and reflect about 50% of a received light, and may be referred to as a “50/50 mirror.”

The second optical element 810 may have a first surface 810-1 facing the first optical element 805 and an opposing second surface 810-2 facing the eye 865. The pancake lens assembly 801 may also include a linear reflective polarizer 808, which may be an individual layer, film, or coating disposed at (e.g., bonded to or formed at) the second optical element 810. The linear reflective polarizer 808 may be disposed at (e.g., bonded to or formed at) the first surface 810-1 or the second surface 810-2 of the second optical element 810 and may receive a light output from the mirror 806. For discussion purposes, FIG. 8A shows that the linear reflective polarizer 808 is disposed at (e.g., bonded to or formed at) the first surface 810-1 of the second optical element 810. That is, the linear reflective polarizer 808 may be disposed between the first optical element 805 and the second optical element 810. In some embodiments, the linear reflective polarizer 808 may be disposed at the second surface 810-2 of the second optical element 810.

The pancake lens assembly 801 shown in FIG. 8A is for illustrative purposes. In some embodiments, one or more of the first surface 805-1 and the second surface 805-2 of the first optical element 805 and the first surface 810-1 and the second surface 810-2 of the second optical element 810 may be curved surface(s) or flat surface(s). In some embodiments, the pancake lens assembly 801 may have one optical element or more than two optical elements.

FIG. 8B illustrates a schematic cross-sectional view of an optical path 880 of an image light propagating in the pancake lens assembly 801 shown in FIG. 8A, according to an embodiment of the present disclosure. In the light propagation path 880, the change of polarization of the image light is shown. The first optical element 805 and the second optical element 810, which are presumed to be lenses that do not affect the polarization of the light, are omitted for the simplicity of illustration. In FIG. 8B, “s” denotes an s-polarized light, and “p” denotes a p-polarized light. For illustrative purposes, the display device 850, the mirror 806, and the linear reflective polarizer 808 are illustrated as flat surfaces in FIG. 8B. In some embodiments, one or more of the display device 850, the mirror 806, and the linear reflective polarizer 808 may include a curved surface.

For discussion purposes, the display device 850 may output a p-polarized image light 821p covering a predetermined spectrum, such as a portion of the visible spectral range or substantially the entire visible spectral range. The mirror 806 may reflect a first portion of the p-polarized image light 821p as an s-polarized image light 823s toward the display device 850, and transmit a second portion of the p-polarized image light 821p as a p-polarized image light 825p toward the linear reflective polarizer 808. The s-polarized image light 823s may be absorbed by a linear polarizer (e.g., similar to the linear polarizer 130 shown in FIGS. 1A-5C) of the display device 850. For discussion purpose, the linear reflective polarizer 808 may be configured to substantially reflect a p-polarized light, and substantially transmit an s-polarized light. Thus, the linear reflective polarizer 808 may reflect the p-polarized image light 825p as a p-polarized image light 827p back toward the mirror 806. The mirror 806 may reflect the p-polarized image light 827p as an s-polarized image light 829s toward the linear reflective polarizer 808, which may be transmitted through the linear reflective polarizer 808 as an s-polarized image light 831s. The s-polarized image light 831s may be focused onto the eye 865.

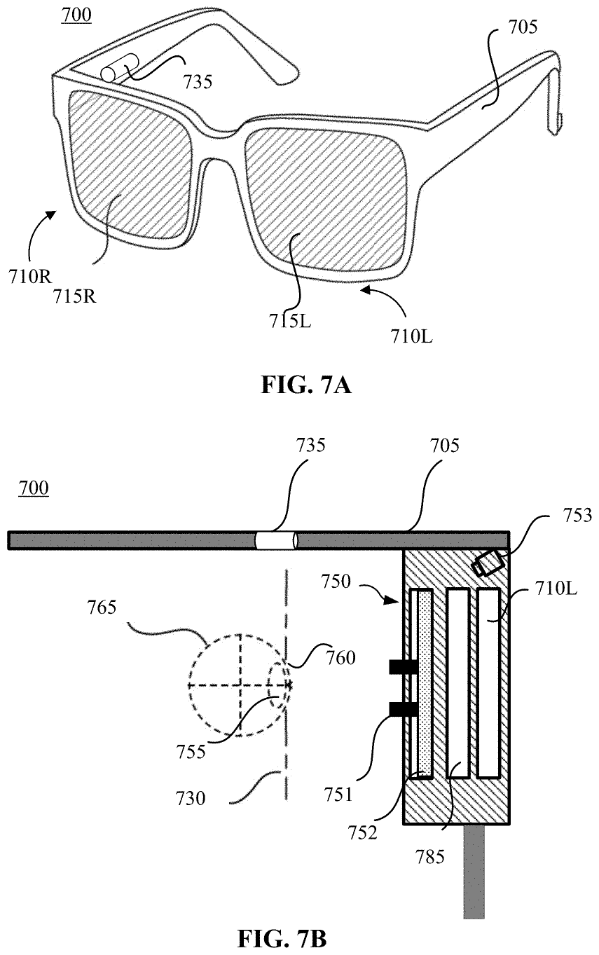

FIG. 7A illustrates a schematic diagram of a near-eye display (“NED”) 700 according to an embodiment of the disclosure. FIG. 7B is a cross-sectional view of half of the NED 700 shown in FIG. 7A according to an embodiment of the disclosure. For purposes of illustration, FIG. 7B shows the cross-sectional view associated with a left-eye display system 710L. The NED 700 may include a controller (e.g., the controller 217), which is not shown in FIG. 7A or 7B. The NED 700 may include a frame 705 configured to mount to a user's head. The frame 705 is merely an example structure to which various components of the NED 700 may be mounted. Other suitable fixtures may be used in place of or in combination with the frame 705. The NED 700 may include right-eye and left-eye display systems 710R and 710L mounted to the frame 705. The NED 700 may function as a VR device, an AR device, an MR device, or any combination thereof. In some embodiments, when the NED 700 functions as an AR or an MR device, the right-eye and left-eye display systems 710R and 710L may be entirely or partially transparent from the perspective of the user, which may provide the user with a view of a surrounding real-world environment. In some embodiments, when the NED 700 functions as a VR device, the right-eye and left-eye display systems 710R and 710L may be opaque, such that the user may be immersed in the VR imagery based on computer-generated images.

The right-eye and left-eye display systems 710R and 710L may include image display components configured to project computer-generated virtual images into left and right display windows 715L and 715R in a field of view (“FOV”). The right-eye and left-eye display systems 710R and 710L may include any disclosed display devices, such as the display device 100 shown in FIG. 1A, the display device 190 shown in FIG. 1G, the display device 400 shown in FIG. 4A, or the display device 455 shown in FIG. 4D. For illustrative purposes, FIG. 7A shows that the right-eye and left-eye display systems 710R and 710L may include a micro-display device 735 coupled to the frame 705. The micro-display device 735 may be any disclosed display device, such as the display device 100 shown in FIG. 1A, the display device 190 shown in FIG. 1G, the display device 400 shown in FIG. 4A, or the display device 455 shown in FIG. 4D. In some embodiments, the micro-display device 735 may be configured with a high display resolution and a high power efficiency. The micro-display device 735 may generate an image light representing a virtual image.

As shown in FIG. 7B, the NED 700 may also include a lens system (or viewing optical system) 785 and an object tracking system 750 (e.g., eye tracking system and/or face tracking system). The lens system 785 may be disposed between the object tracking system 750 and the left-eye display system 710L. The lens system 785 may be configured to guide the image light output from the left-eye display system 710L to an exit pupil 760. The exit pupil 760 may be a location where an eye pupil 755 of an eye 765 of the user is positioned in an eye-box region 730 of the left-eye display system 710L. The lens system (or viewing optical system) 785 may be polarization selective or non-polarization selective. In some embodiments, the lens system 785 may be configured to correct aberrations in the image light output from the left-eye display system 710L, magnify the image light output from the left-eye display system 710L, or perform another type of optical adjustment to the image light output from the left-eye display system 710L. The lens system 785 may include multiple optical elements, such as lenses, waveplates, reflectors, etc. In some embodiments, the lens system 785 may include a pancake lens configured to fold the optical path, thereby reducing the back focal distance in the NED 700. The pancake lens assembly may be any embodiment of the pancake lens assemblies disclosed herein, such as the pancake lens assembly 801 shown in FIG. 8A. The object tracking system 750 may include an IR light source 751 configured to illuminate the eye 765 and/or the face, a deflecting element 752 configured to deflect the IR light reflected by the eye 765, and an optical sensor 753 configured to receive the IR light deflected by the deflecting element 752 and generate a tracking signal.

Any of the steps, operations, or processes described herein may be performed or implemented with one or more hardware and/or software modules, alone or in combination with other devices. In one embodiment, a software module is implemented with a computer program product including a computer-readable medium containing computer program code, which can be executed by a computer processor for performing any or all of the steps, operations, or processes described. In some embodiments, a hardware module may include hardware components such as a device, a system, an optical element, a controller, an electrical circuit, a logic gate, etc.

Further, when an embodiment illustrated in a drawing shows a single element, it is understood that the embodiment or another embodiment not shown in the figures but within the scope of the present disclosure may include a plurality of such elements. Likewise, when an embodiment illustrated in a drawing shows a plurality of such elements, it is understood that the embodiment or another embodiment not shown in the figures but within the scope of the present disclosure may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one figure/embodiment but not shown in another figure/embodiment may nevertheless be included in the other figure/embodiment. In any optical device disclosed herein including one or more optical layers, films, plates, or elements, the numbers of the layers, films, plates, or elements shown in the figures are for illustrative purposes only. In other embodiments not shown in the figures, which are still within the scope of the present disclosure, the same or different layers, films, plates, or elements shown in the same or different figures/embodiments may be combined or repeated in various manners to form a stack.

Various embodiments have been described to illustrate the exemplary implementations. Based on the disclosed embodiments, a person having ordinary skills in the art may make various other changes, modifications, rearrangements, and substitutions without departing from the scope of the present disclosure. Thus, while the present disclosure has been described in detail with reference to the above embodiments, the present disclosure is not limited to the above described embodiments. The present disclosure may be embodied in other equivalent forms without departing from the scope of the present disclosure. The scope of the present disclosure is defined in the appended claims.

What is claimed is:

1. A device, comprising:
a light source configured to output a light;
a display panel including a plurality of subpixel areas; and
a microlens assembly disposed between the light source and the display panel, the microlens assembly including a first microlens array configured to substantially collimate the light into a first polarized light, and a second microlens array configured to focus the first polarized light as a second polarized light propagating through apertures of the subpixel areas.

2. The device of claim 1, wherein the second polarized light propagates substantially entirely through the apertures of the subpixel areas.

3. The device of claim 1,
wherein the display panel includes a plurality of color filters, and
wherein the second polarized light propagates substantially entirely through the color filters.

4. The device of claim 1, wherein the first microlens array is a first Pancharatnam Berry Phase (“PBP”) microlens array, and the second microlens array is a second PBP microlens array.

5. The device of claim 1, wherein each subpixel area of the plurality of subpixel areas includes a subpixel electrode and a switching element of the subpixel electrode, the subpixel electrode corresponding to an aperture of the subpixel area, and the switching element corresponding to a non-transparent portion of the subpixel area.

6. The device of claim 1, wherein the first polarized light and the second polarized light are circularly polarized lights having opposite handednesses.

7. The device of claim 1, wherein the light output from the light source is a circularly polarized light.

8. The device of claim 1, wherein an alignment offset between the first or second microlens array and an array formed by the apertures of the subpixel regions is less than or equal to 2 μm.

9. The device of claim 1, wherein the first polarized light has a collimation angle that is within a range of about 5° to about 15°.

10. The device of claim 1, wherein the microlens assembly includes a waveplate disposed between the second microlens array and the display panel.

11. The device of claim 10, wherein the microlens assembly includes a reflective polarizer disposed between the waveplate and the display panel, and a linear polarizer disposed between the reflective polarizer and the display panel.

12. A device, comprising:
a plurality of light-emitting elements configured to emit an image light;
a polarization converter including a plurality of converting regions and non-converting regions; and
a microlens array disposed between the light-emitting elements and the polarization converter, the microlens array including a plurality of microlenses configured to transform a first portion of the image light as a first polarized light that is incident onto the converting regions, and transform a second portion of the image light as a second polarized light that is incident onto both of the converting regions and the non-converting regions.

13. The device of claim 12, wherein the microlens array includes a transmissive polarization volume hologram (“PVH”) microlens array.

14. The device of claim 12, wherein
the microlenses include a plurality of central portions and periphery portions,
the first portion of the image light includes portions of the image light that are incident onto central portions of the microlenses and that are circularly polarized with a first handedness, and
the second portion of the image light includes a combination of portions of the image light that are incident onto the central portions of the microlenses and that are circularly polarized with a second handedness, and portions of the image light that are incident onto the periphery portions of the microlenses.

15. The device of claim 12, wherein a beam size of the first polarized light at a plane intersecting one of the converting regions is configured to be the same as or smaller than a size of the one of the converting regions.

16. The device of claim 12, wherein an alignment offset between the microlens array and the light-emitting elements is less than or equal to 2 μm.

17. The device of claim 12, wherein the first polarized light has a first polarization, and the second polarized light has a second polarization that is orthogonal to the first polarization.

18. The device of claim 17, wherein
the second polarized light includes first portions incident onto the converting regions and second portions incident onto the non-converting regions,
the converting regions are configured to convert the first polarized light having the first polarization into a third polarized light having the second polarization, and convert the first portions of the second polarized light having the second polarization into a fourth polarized light having the first polarization, and
the non-converting regions are configured to transmit the second portions of the second polarized light having the second polarization as a fifth polarized light having the second polarization.

19. The device of claim 18, further comprising a circular polarizer configured to substantially transmit the third polarized light having the second polarization and the fifth polarized light having the second polarization, and substantially block the fourth polarized light having the first polarization.

20. The device of claim 19, wherein the circular polarizer includes a first waveplate, a linear polarizer, and a second waveplate stacked together.
